(19) United States
(12) Patent Application Publication
(10) Pub. No.: US 2024/0258564 A1
(43) Pub. Date: Aug. 1, 2024

(54) IONIC LIQUID INSPIRED ZWITTERIONS WITH HIGH CONDUCTIVITY AND TRANSPORT NUMBER

(71) Applicant: THE REGENTS OF THE UNIVERSITY OF CALIFORNIA, Oakland, CA (US)

(72) Inventors: Seamus D. Jones, Goleta, CA (US); Yanqiao Chen, Goleta, CA (US); Peter Richardson, Santa Barbara, CA (US); Raphaele Clement, Santa Barbara, CA (US); Craig J. Hawker, Santa Barbara, CA (US); Glenn H. Fredrickson, Santa Barbara, CA (US); Rachel A. Segalman, Santa Barbara, CA (US)

(73) Assignee: THE REGENTS OF THE UNIVERSITY OF CALIFORNIA, Oakland, CA (US)

(21) Appl. No.: 18/555,081

(22) PCT Filed: Apr. 12, 2022
(86) PCT No.: PCT/US22/24461

§ 371 Date: Oct. 12, 2023

Related U.S. Application Data
(60) Provisional application No. 63/318,574, filed on Mar. 10, 2022.
(60) Provisional application No. 63/248,769, filed on Sep. 27, 2021.
(60) Provisional application No. 63/174,026, filed on Apr. 12, 2021.

(51) Int. Cl. H01M 10/0565

(52) U.S. Cl. CPC H01M 10/0565; H01M 2300/0082

(57) ABSTRACT

A solid electrolyte including zwitterionic compounds comprising zwitterionic molecules and/or charge neutral polymers with zwitterion pendants. A salt is distributed through the solid such that the solid conducts alkali metal ions obtained from the salt and the zwitterionic compounds each include zero or more amorphous regions and one or more crystalline regions characterized by (1) a presence of Bragg diffraction peaks in an X-ray diffraction measurement of the solid; and (2) the solid having an ion conductivity of at least 10⁻⁴ S/cm at a temperature of 50 degrees Celsius when a transport number for the alkali metal ions is at least 0.5 and a molar ratio of the salt to the zwitterionic units is 0.9. The electrolyte exhibits surprisingly high alkali metal ion conductivity and linear elastic modulus over a wide range of practically useful temperatures.

### CROSS REFERENCE TO RELATED APPLICATIONS

This application claims the benefit under 35 U.S.C. Section 119(e) of the following co-pending and commonly-assigned U.S. Provisional Patent Applications:
63/174,026 filed Apr. 12, 2021, by Seamus D. Jones, Glenn H. Fredrickson, and Rachel A. Segalman, entitled “POLYMER ZWITTERIONIC LIQUIDS WITH HIGH CONDUCTIVITY AND TRANSPORT NUMBER” Attorney's Docket No. 30794.800-US-P1,
63/248,769 filed Sep. 27, 2021, by Seamus D. Jones, Yangiao Chen, Peter Richardson, Raphaele Clement, Craig Hawker, Glenn H. Fredrickson, and Rachel A. Segalman, entitled “IONIC LIQUID INSPIRED ZWITTERIONS WITH HIGH CONDUCTIVITY AND TRANSPORT NUMBER” Attorney's Docket No. 30794.800-US-P2, and
63/318,574 filed Mar. 10, 2022, by Seamus D. Jones, Yangiao Chen, Peter Richardson, Raphaele Clement, Craig Hawker, Glenn H. Fredrickson, and Rachel A. Segalman, entitled “ZWITTERIONS MATERIALS WITH HIGH CONDUCTIVITY AND TRANSPORT NUMBER” Attorney's Docket No. 30794.800-US-P3,
all of which applications are incorporated by reference herein.

### STATEMENT REGARDING FEDERALLY SPONSORED RESEARCH AND DEVELOPMENT

This invention was made with Government support through grant no. DMR-1720256 (IRG-2) awarded by the National Science Foundation. The Government has certain rights in this invention.

### BACKGROUND OF THE INVENTION

### 1. Field of the Invention

The present disclosure relates to electrolytes and methods of making the same.

### 2. Description of the Related Art

(Note: This application references a number of different references as indicated throughout the specification by one or more reference numbers in parentheses, e.g., (x). A list of these different publications ordered according to these reference numbers can be found below in the section entitled “References.” Each of these references is incorporated by reference herein.)

The efficient and safe storage of electrochemical energy is critical for emerging technologies such as electric vehicles and portable electronic devices. Practical requirements for next-generation secondary batteries include higher energy densities and charge-discharge rates, which hinge on new high-voltage cathode materials and on electrodes and electrolyte components with high ionic conductivities (a). The wide operating potential window of such cells exceeds the safe operation limits of current organic solvent-based electrolytes and necessitates the design of alternative electrolytes that are leak-proof, electrochemically stable and nonflammable. Solid Polymer Electrolytes (SPEs) have attracted significant interest in this area for their stability and mechanical robustness. However, due to the strong coupling of polymer segmental relaxation rates with ion mobilities, it remains challenging to attain sufficiently high ionic conductivities across the battery operating temperature range without compromising the mechanical properties. What is needed are solid electrolytes with improved ion conduction and mechanical properties. The present disclosure satisfies this need.

### SUMMARY OF THE INVENTION

To address these challenges, the present disclosure describes ionic-liquid inspired crystalline zwitterionic (ZI) solid electrolytes designed to decouple ion transport from the fluidity of the matrix. This decoupling confers superionic performance resembling that of inorganic solid-state electrolytes, while the surrounding matrix leads to processability and ductility akin to traditional polymeric electrolytes.

Illustrative embodiments include, but are not limited to, the following examples.

1. A solid electrolyte comprising:
a solid comprising zwitterionic compounds each comprising one or more cations and one or more anions, the zwitterionic compounds comprising at least one of zwitterionic molecules or charge neutral polymers comprising zwitterion pendants; and
an electrolyte salt distributed through the solid such that the solid conducts the alkali metal ions obtained from the salt and the zwitterionic compounds each include zero or more amorphous regions and one or more crystalline regions characterized by:
a presence of Bragg diffraction peaks in an X-ray diffraction measurement of the solid; and
the solid optionally having an ion conductivity of at least 10⁻⁴ S/cm at a temperature of 50 degrees Celsius when:
a molar ratio r of the salt to the zwitterionic monomer units in the charge neutral polymers is 0.9 and optionally when the molar ratio r of the salt to the zwitterionic units in the zwitterionic molecules is 0.9.

2. The solid electrolyte of example 1, wherein the solid comprises a blend of the zwitterionic molecules and the charge neutral polymers.

3. The solid electrolyte of any of the examples 1-2, wherein the charge neutral polymers each comprise:
a backbone comprising a plurality of backbone monomers; and
a plurality of side chains, each of the side-chains attached to one of the backbone monomers, wherein:
at least one of the side chains each include at least one of the zwitterionic monomer units comprising at least one of the cations and at least one of the anions of compensating charge; and
the charge neutral polymers comprise one or more of the crystalline regions and one or more of the amorphous regions.

4. The solid electrolyte of any of the examples 1-3, wherein:
the zwitterionic molecules each comprise one or more of the cations and one or more of the anions; and
the zwitterionic molecules are located in one or more of the crystalline regions. 5. The solid electrolyte of any of the examples, wherein the cations and the anions have sizes and shapes so that the crystalline regions include, or are separated by void spaces or vacancies sufficiently large to selectively allow passage of the alkali metal ions through the voids or vacancies such that the solid conducts the alkali metal ions with a transport number of at least 0.5.

6. The solid electrolyte of any of the examples 1-5, wherein the alkali metal ions are preferentially transported through the crystalline regions that form a percolation path through a surrounding matrix comprising the material of the solid

7. The solid electrolyte of any of the examples 1-6, wherein the solid is not cross-linked and thereby remains soluble and/or melt processible.

8. The solid electrolyte of any of the examples 1-7, wherein the crystalline regions are arranged and dimensioned such that a conduction of the alkali metal ions is characterized by ballistic transport in a crystal.

9. The solid electrolyte of any of the examples 1-8, wherein the solid is characterized by a linear elastic modulus of at least 100 kilopascals at room temperature (30 degrees Celsius) under a deformation frequency of 0.1 Hz.

10. The solid electrolyte of any of the examples 1-9 wherein the molar ratio r is in a range 0.05≤r≤2.

11. The solid electrolyte of any of the examples 1-10, wherein:
the crystalline regions are dimensioned and arranged such that the solid has the ion conductivity of at least 10⁻⁴ S/cm at a temperature 30 of degrees Celsius, and the transport number for the alkali metal ions is at least 0.5.

12. The solid electrolyte of any of the examples 1-11, wherein:
the crystalline regions are dimensioned and arranged such that the solid has the ion conductivity of at least 10⁻⁶ S/cm at a temperature −15 degrees Celsius, and
the transport number for the alkali metal ions is at least 0.5.

13. The solid electrolyte of any of the examples 1-12, wherein:
the crystalline regions are dimensioned and arranged such that the solid has the ion conductivity of at least 10⁻⁵ S/cm at a temperature 0 degrees Celsius, and the transport number for the alkali metal ions is at least 0.5.

14. The solid electrolyte of any of the examples 1-13, wherein the alkali metal ions are lithium ions, zinc ions, magnesium ions, copper ions, sodium ions, or calcium ions.

15. The solid electrolyte of any of the examples 2-14, wherein:
the side chains have a regular or periodic spacing along the backbone; and
the cations and anions are sufficiently bulky to allow formation of a free volume between the side chains, the free volume so dimensioned to allow transport of the alkali metal ions through the free volume.

16. The solid electrolyte of any of the examples 1-15, wherein:
the side-chains each have an alkyl, an ether, or siloxane linker connecting the zwitterionic monomer to the backbone, and
the linker has a length in a range of 1-30 atoms so as to allow crystallization of the side chains.

17. The solid electrolyte of any of the examples 1-16, wherein the cation comprises an imidazolium and the anion comprises a group having the formula —SO₂N⁻SO₂—.

18. The solid electrolyte of any of the examples 1-17, wherein the cation comprises an ammonium and the anion comprises group having the formula —SO₂N⁻SO₂—.

19. The solid electrolyte of any of the examples 2-18, wherein the charge neutral polymer has one of the structures shown in FIGS. 21A-21D,
wherein:
BR, BR1, BR2 are the backbone monomers,
the cation comprises C, C1, or C2,
the anion comprises A, A1, A2,
the side-chains comprise L, L′, L1, L1′, L2, L2′ comprising aliphatic linker moieties covalently connecting the zwitterionic monomers to the backbone monomers, and
T, T′, T1, T2 comprise end groups terminating the side chains.

20. The solid electrolyte of any of the examples 1-15, wherein the backbone comprises a polysiloxane backbone, a polyolefin backbone, a polystyrene backbone, a polyacrylate backbone, a polymethacrylate backbone, or a vinyl polymer backbone.

21. The solid electrolyte of any of the examples 1-20, wherein the solid comprises a blend comprising the zwitterionic compounds and an additive, binder, or additional component.

22. The solid electrolyte of example 21, wherein the additive or additional component comprises a nucleating agent or a component enhancing the crystallinity of the crystalline regions or mechanical properties of the solid.

23. The solid electrolyte of any of the examples 1-22 wherein the one or more crystalline regions comprise one or more smectic crystals.

24. The solid electrolyte of any of the examples 1-23 comprising crystallographic disorder.

25. The solid electrolyte of any of the examples 1-24, wherein the zwitterionic compounds comprise the zwitterionic molecules but not the charge neutral polymers.

26. The solid electrolyte of any of the examples 1-25, wherein the solid has been crosslinked during or after solution or melt processing to enhance its mechanical performance.

27. The solid electrolyte of any of the examples, wherein an ionic conductivity of the electrolyte in the absence of the salt is <10⁻¹¹ S/cm so that a majority of the conductivity comprises the conductivity of the alkali metal ions.

28. The solid electrolyte of any of the examples 1-27, wherein the transport number t⁺ is defined as the proportion of the ion conductivity which arises from the alkali metal ions and if the relative concentration of anions and cations are equal, then the transport number can be determined as follows:

$${t}_{+} = \frac{{σ}_{+}}{{σ}_{+} + {σ}_{-}}$$

where σ₊ is a first component of a conductivity of the solid electrolyte arising from the alkali metal ions (cations) and σ₋ is a second component of the conductivity attributed to any other ions different from the alkali metal ions, including anions.

29. The solid electrolyte of any of the examples 1-28, comprising a solid polymer electrolyte.

30. The solid electrolyte of any of the examples 1-29, wherein the crystalline regions are three dimensional and a percolation path for conduction of the alkali metal ions through the solid extends in 3 dimensions.

31. The solid electrolyte of any of the examples 1-30, wherein a salt comprised of the cation and the anion, when separate from the zwitterionic compounds, has a melting temperature below 100 degrees Celsius.

32. The solid electrolyte of any of the examples 1-31, wherein the anions are ionic liquid like or are larger than anions comprising SO₃.

33. The solid electrolyte of any of the examples 1-32, wherein the anions and cations are selected from the following:

### Monovalent Cations:

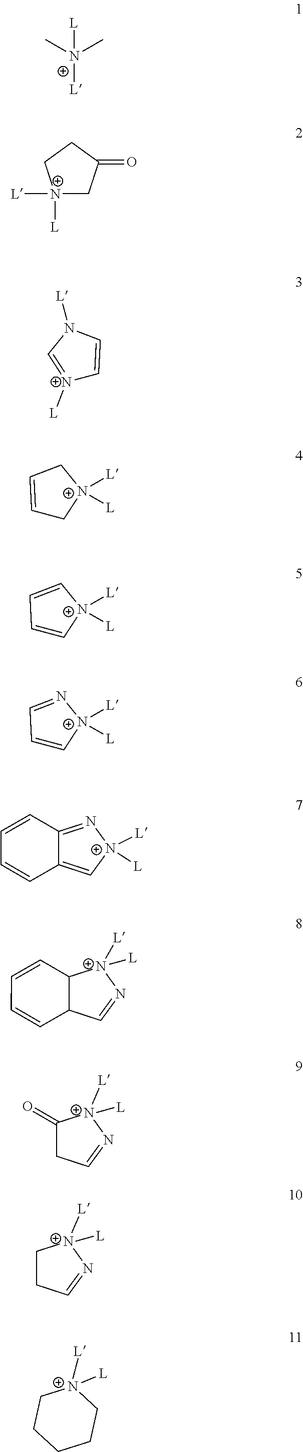

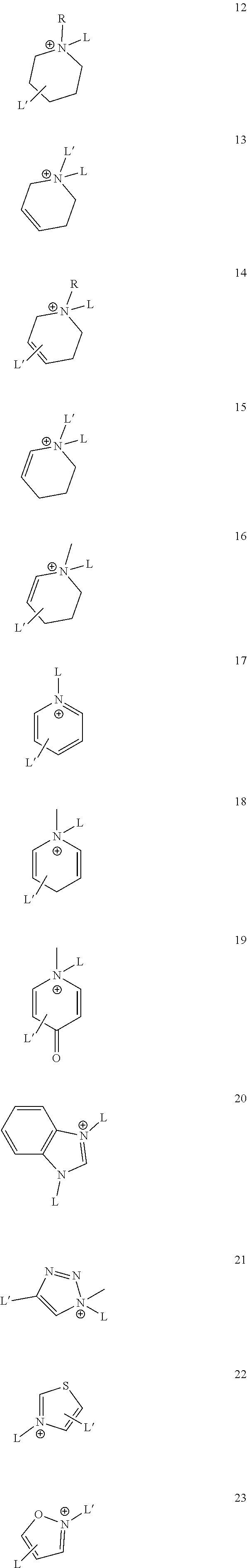

### Bivalent Cations:

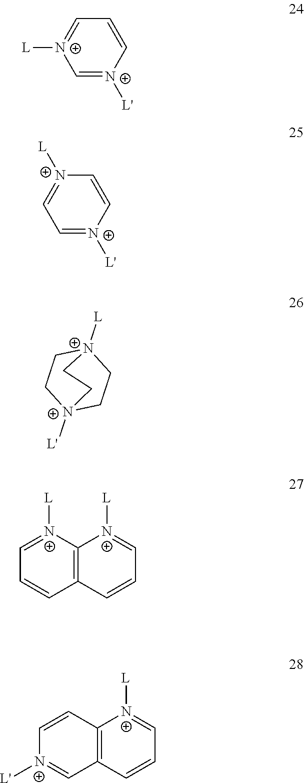

### Monovalent Anions

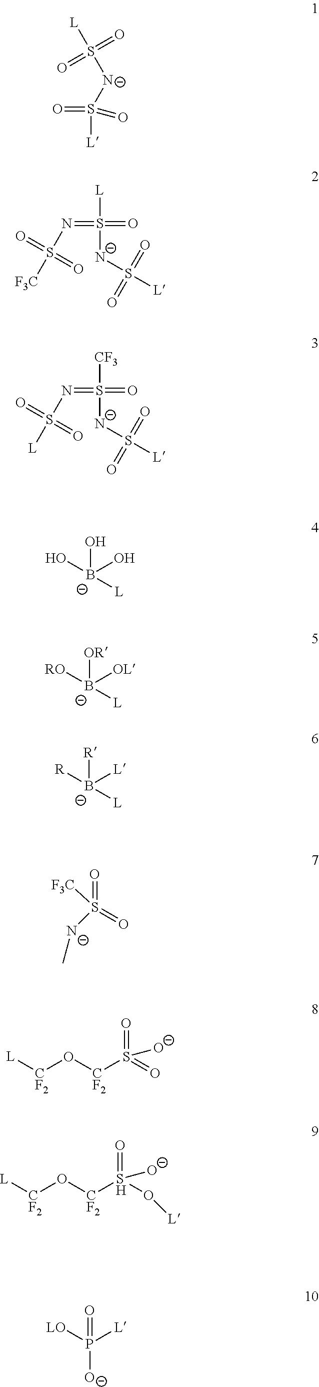

### Bivalent Anions:

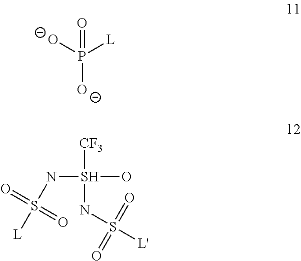 [0074] or the zwitterionic compounds comprise or are selected from one more or more of the following:

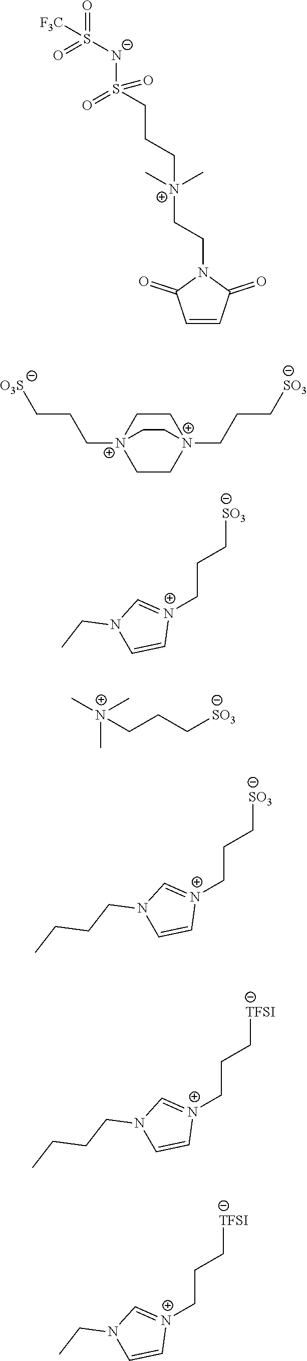

34. The solid electrolyte of any of the examples 1-33, wherein the zwitterionic compounds comprise ionic liquid inspired zwitterions comprising the anions and cations that form the solid electrolyte comprising a crystalline solid at temperatures at which the electrolyte is used or operated.

35. The solid electrolyte of any of the examples 1-34, wherein the solid has the ion conductivity of at least 10⁻⁴ S/cm at the temperature of 50 degrees Celsius when a transport number for the alkali metal ions is at least 0.5.

36. A battery comprising the solid electrolyte of any of the examples 1-35 in contact with an anode and a cathode

### BRIEF DESCRIPTION OF THE DRAWINGS

Referring now to the drawings in which like reference numbers represent corresponding parts throughout:

FIG. 1: A schematic representation of the path of an ion through (A) a typical solid polymer electrolyte, in which ion transport is coupled to the timescale of local rearrangements, and (B) an ordered solid with sufficient free volume to enable superionic transport. The atoms of a crystal are typically confined to specific lattice positions, allowing sufficiently small ions with a low charge (blue spheres) to diffuse though the matrix (red spheres) via successive discrete hops involving vacant lattice sites or interstitial sites, while the motion of larger or highly charged ions (green sphere) is excluded. (C) The zwitterionic polymer studied herein comprises IL-inspired ions tethered to the backbone. Mobile ions are doped in through the addition of a Li⁺TFSI⁻ salt at select molar ratios. D) The DC ionic conductivity of salt-containing polymeric zwitterions (PZIs) shown as a function of temperature is comparable to that of PEO (a best-in-class SPE)(24). E) While standard SPEs have molar ionic conductivities coupled directly to the timescale of molecular rearrangements, (τ_{g}˜1/Λ), the salt-containing ZIs demonstrate decoupling of these properties. Amorphous poly(ethylene oxide)(PEO) and poly(propylene glycol) (PPG) serve as reference SPEs, and ((Ag)_{0.5}—(AgPO₃)_{0.5}) systems are typical superionic inorganic solids (literature data on PEO, PPG, and Ag systems from Sokolov(1)).

FIG. 2: Structural analysis of the PZI indicates the presence of two phases, one containing an ordered structure very similar to the small molecule on which the PZI was based and another amorphous phase. A) WAXS curves demonstrate the presence of amorphous and ordered structures within the PZI sample. The crystalline peaks of a small molecule analog for this material appear to match well with the Bragg peaks of the PZI, suggesting a structural similarity between the structure of the small molecule crystal and the polymer. B) Schematic representation of the conduction mechanism in the polymer suggested by NMR Diffusometry. The amorphous domains are proposed to promote motion of lithium and its counterion through vehicular motion, the ordered domains are suggested to have high selectivity for lithium, transported via a ballistic conduction mechanism.

FIG. 2: C) Line shape analysis of the 1D ⁷Li NMR spectrum. The blue curve is the experimental data, the pink curve is the broad Gaussian component and the green curve is the narrow gaussian component with the red curve representing the sum of these components. The fit using two Gaussian lines centered at very similar resonant frequencies demonstrates that lithium exists in two environments that are chemically similar but display different dynamics. D) The Li⁷ pulsed field gradient profile with fits based on one and two components. The diffusion profile requires two signal components to fit the decay, with relative weights in line with the populations of the two lithium environments determined from the fit of the 1D ⁷Li NMR line shape in C). E) The ⁷Li T₁ₚ relaxometry curve with one- and two-component fits reveals once again that two lithium populations are necessary to fit the decay curve. The size of these populations again agrees with the 1D and PFG-NMR results. F) The ¹⁹F line shape analysis with the same curve labels as in panel C. In this case, the widths of the curves are similar, but the chemical shifts differ more significantly, suggesting the presence of two chemical environments, tentatively assigned to polymer-bound and free fluorine-containing species. G) The ¹⁹F diffusion curve can be fit assuming a single diffusion mode, suggesting that all mobile fluorine exists in a similar diffusing environment. H) The diffusion coefficients obtained from PFG-NMR experiments as a function of inverse temperature demonstrate that the amorphous conductivities of the lithium and fluorine are similar, suggesting that the high conductivity of these electrolytes is derived from the motion of lithium through the crystalline domains of the material.

FIG. 3: A) A Robeson-inspired plot captures the traditional tradeoff between ionic selectivity (transference or transport number) versus permeability (conductivity). Unfilled symbols are values reported by Balsara and coworkers(7) demonstrating the observed upper bound for these systems based on matrix molecular motion enabled ion transport. In comparison, the superionic ZIs and PZIs studied here have comparable conductivities but much higher selectivity than the best conventional polymeric electrolytes. B) The table indicates the selectivity metrics and conductivities for ZI and PZI electrolytes. ρ₊ indicates the electrochemically-determined, limiting current fraction (Section 9 of Appendix B in the priority application U.S. Ser. No. 63/248,769, hereinafter Appendix B) and t₊ indicates the transport number determined by PFG-NMR (Section 7 of Appendix B). σ indicates the total ionic conductivity determined from EIS.

FIG. 4: Room temperature conductivity of imidazolium-TFSI zwitterionic polymer as a function of salt loading.

FIG. 5: A schematic representation of various ionic molecules. Zwitterions differentiate themselves by having both positive and negative charges in the same covalently bound molecule. The zwitterions of highest interest are composed of bulky charges such that the corresponding salt without connectivity between these ions has a melting point below 100° C.

FIG. 6: Example ZI molecules which have been synthesized. More examples of cations, anions, linker groups and tail groups for ZI molecules can be found in FIG. 21E.

FIG. 7: A) Structure of ZI investigated by microscopy. B and C) Images of the zwitterionic crystal in the absence of added salt viewed through optical microscopy at 10×. D) The zwitterionic crystal doped with 10% by mass LiTFSI salt and compressed into a flat film. Viewed at 50×. E) The zwitterionic crystal doped with 10% by mass LiTFSI viewed at 10×. This image shows clear evidence of crystallinity.

FIG. 8: WAXS patterns of zwitterion molecules in the absence of salt at room temperature demonstrate that each compound has a unique crystal structure that is dictated by the choice of the cation and anion. The melting temperature is also dictated by the ion choice.

FIG. 9 shows the evolution of the WAXS scattering pattern as LiTFSI salt is added to the zwitterion molecules. Evidence of disorder emerges at 20 wt % salt as indicated by a disordered correlation peak at q₁˜0.32 Å⁻¹ corresponding to a real spacing of ˜2 nm. At higher weight fractions of salt, the sharp Bragg reflections give way to liquidlike peaks at q₂˜1.3 Å⁻¹ corresponding to real spacing of 4.8 Å, this may correspond to an ion-ion spacing or an average liquid like packing.

FIG. 10: A ZI molecule along with its crystalline structure in a solid.

FIG. 11: A ZI molecule along with its crystalline structure in a solid, wherein the pore or void spaces in the structure of FIG. 11 are larger than in the structure of FIG. 10.

FIG. 12: Normalized current versus time graph of a symmetric Li:Li cell with ZI as the electrolyte during polarization. In this case, the initial current I₀=5.53 μAmperes. The inset indicates the chemical structure of the tested ZI.

FIG. 13A-13B: Ionic conductivity measurements of the ZI as a function of temperature during a heating and cooling cycle. The inset indicates the chemical structure of ZI tested. FIG. 13A indicates the apparent conductivity in the absence of salt, and FIG. 13B indicates the real conductivity in the presence of added LiTFSI salt. The conductivity in FIG. 13B is measured at 10 wt % LiTFSI salt, so this corresponds to r=0.135 in the definition of
r=[moles salt]/[moles zwitterion]. The data from FIG. 13B is used to feed into the ionic conductivity values in FIG. 3.

FIG. 13C shows ionic conductivity of a PZI with zwitterion pendants comprising SO₃— anion or TFSI anion, showing conductivity increased when anion is larger than SO₃—)

FIG. 14: A) Individual frequency sweep curves from the r=0.1 zwitterionic system with closed symbols representing the storage modulus (G′) and open symbols representing the loss modulus (G″). B) The master curve for the r=0.1 system generated by shifting in frequency only and generated at a reference temperature of 30° C. Solid and dotted fit lines correspond to the fitting of the glassy region to the KWW relation (Equation 1), which provides a phenomenological description of the glass transition. The marked τ_{g} curve represents the mean glassy relaxation timescale as estimated by the KWW fit. C) Master curves for all salt loaded polymers display similar behavior. The reference temperature of the r=0.1 curve is 30° C., the r=0.3 and r=0.9 were selected at the same reference temperature and shifted by factors of 10³ and 10⁶ respectively so they can be more easily visualized in a single figure. D) The shift factor versus temperature curves for all salt loadings with a reference temperature of 900° C.

FIG. 15. The decomposition profiles of the imidazolium-TFSI ZI and PZI are shown in the TGA curve with a ramp rate of 10 C/minute. The onset of mass loss for the PZI, indicated by the temperature at which 1% of mass has been lost, is found to be 180° C., so this temperature was utilized as a maximum temperature for further thermal analysis. Evidently there are two reaction stages for degradation of both the PZIs and the ZI indicated by the presence of an initial drop in the mass % remaining at ˜200° C. and a second more severe drop at ˜350° C.

FIG. 16: Thermal characterization of PZI. First pass of the calorimetric cycle is indicated by the dotted line, the second heating is indicated by the solid line. In the first pass, an endotherm is evident for all samples, typically an endotherm in DSC is typical of either 1) a melting temperature or 2) an enthalpy of vaporization of a volatile component. Since there is no removal of any volatile component evident in TGA analysis of the sample and since the samples were thoroughly dried and packed in a glovebox, we conclude that this peak is evident of some crystalline melting. The melting temperatures in all cases are relatively constant at ˜130° C. This is remarkably consistent with the melting temperature of the small molecule crystallite. We note again that agreement between the small molecule crystal and the polymer crystal is fortuitous in this case since tethering the molecule to the polymer backbone can change many of its properties. Upon a second heating cycle, only a glass transition is observed. This is consistent with the small molecule ZI, in which the slow crystallization dynamics prevent the observation of a second melting.

FIG. 17: The thermal characterization of a zwitterion (inset). This above figure shows a heat-cool-heat cycle of this zwitterion small molecule where the curves are formatted so that they are sequential in time as read from top to bottom and the curves have been shifted for clear viewing. The first heating results in a sharp melting transition as may be expected of a crystalline material. However, upon cooling no crystallization peak is observed and the material instead undergoes a glass transition around −11° C. We observe that this amorphous liquid state is maintained within this ZI for >24 hours but the material eventually converts back to a crystalline solid. The sluggish crystallization kinetics of the small molecule ZI are worth considering in the following analysis of the polymers, which may exhibit even more sluggish crystallization due to the polymer-bound nature of the ZIs.

FIG. 18: A synthetic scheme for the siloxane PZIs. a) Without an amide group in the zwitterion ligand, and b) with an amide group.

FIG. 19: A) Structure of Block Copolymer (BCP) PZIs with styrene blocks.

FIG. 19: B) The fractions and degrees of polymerization of the block copolymers. The ‘possible morphology’ is based on standard block copolymer segregation of neutral block copolymers in the strong segregation limit. We note that this is a simplification of the self-assembly behavior herein, primarily due to the presence of strong coulombic interactions in this system.

FIG. 19: C). Model PZI with alternating zwitterionic groups. By utilizing deuterated styrene, some chains can be labeled for neutron scattering experiments.

FIG. 19: D). Method for synthesizing a block copolymer comprising a PZI, according to one example.

FIG. 19: E). Method for synthesizing a block copolymer comprising a PZI, according to another example.

FIG. 19: F). Method for synthesizing a conjugated polymer comprising a PZI, according to yet another example.

FIG. 20: a) PDMS-b-PZI and b) PS-b-PZI. c) (red) Independent and (gold) dependent variables of design space for zwitterionic BCPs.

FIG. 21. Example polymer structures that can be used in the solid polymer electrolyte.

FIG. 22. Some potential design choices of a 1:1 zwitterion, comprised of a single positive and single negative charge. The indicated structures do not indicate all possible design choices. More examples of cations, anions, linker groups and tail groups can be found in FIG. 21E.

FIG. 23. Some potential charge arrangements for zwitterions containing more than one positive or negative charge per molecule. These combinations indicate charge-neutral zwitterions with the four charges.

FIG. 24. Flowchart illustrating a method of making a solid electrolyte comprising a PZI.

FIG. 25. Flowchart illustrating a method of making a solid electrolyte comprising zwitterionic small molecules.

FIG. 26 is a cross sectional schematic of a battery.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

The present disclosure describes a solid electrolyte comprising zwitterionic compounds each comprising one or more cations and one or more anions. The zwitterionic compounds comprise at least one of zwitterionic molecules or charge neutral polymers comprising zwitterion pendants. An electrolyte salt is distributed through the solid such that the solid conducts the alkali metal ions obtained from the salt and the zwitterionic compounds each include zero or more amorphous regions and one or more crystalline regions characterized by a presence of Bragg diffraction peaks in an X-ray diffraction measurement of the solid. In one or more examples, the solid electrolyte has an ion conductivity of at least 10⁻⁴ S/cm at a temperature of 50 degrees Celsius when a transport number for the alkali metal ions is at least 0.5, and a molar ratio r of the salt to the zwitterionic monomer units in the charge neutral polymers is 0.9 or less and the molar ratio r of the salt to the zwitterionic units in the zwitterionic molecules is less than 0.9.

Various examples of this solid electrolyte are described in the following examples.

### First Example: PZI Compositions Displaying a Faster-than-Vehicular Conduction Mechanism

a. Composition

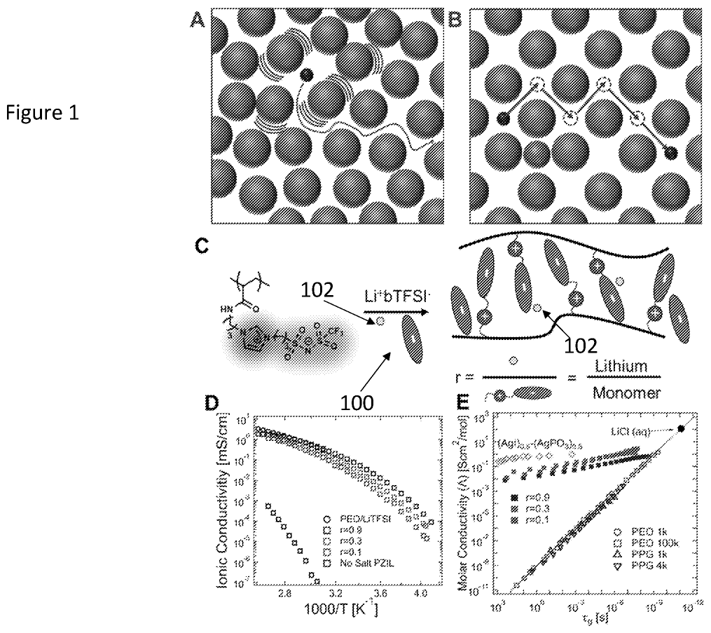

FIG. 1C illustrates example PZIs designed with bulky, immobilized charges, resulting in labile ion-ion interactions and significant free volume for metal cation motion enabling superionic conduction mechanisms. The choice of a bulky, pendant imidazolium-trifluoromethanesulfonamide (Im-TFSI) zwitterion allows for weaker Coulombic interactions, and the asymmetry in cation and anion sizes promotes crystal formation with sufficient void space for Li⁺ ions.

In this example, the choice of salt identity and concentration is critical to maximizing salt dissolution while preventing aggregation and precipitation. Mobile lithium bis(trifluoromethanesulfonimide) (Li⁺/TFSI⁻)) is a highly labile salt whose use leads to facile dissociation in the presence of ion-solvating functionalities. It should also be noted that, due to the solvation afforded by zwitterionic (ZI) groups, salt-to-monomer ratios (parameterized by ‘r’) higher than the upper r=0.9 value presented in FIG. 1 can be obtained without salt precipitation (Section 6 in Appendix B).

b. Electrochemical Impedance Spectroscopy

FIG. 1D illustrates Electrochemical Impedance Spectroscopy (EIS) measurements showing high ionic conductivities for the PZIs and minimal conduction for the parent, undoped polymer. This dramatic (and surprisingly unexpected) conductivity difference demonstrates that the ionic current is carried by the Li⁺/TFSI⁻ dopants, suggesting that the polymer acts as a fixed charged background for the mobile ions. The ionic conductivities of the PZIs are in excess of 1 mS/cm at elevated temperature, an important metric for practical implementation. Doped PZIs achieve competitive ion conductivities despite sluggish segmental motion, indicated by their relatively high glass transition temperatures (Tg˜270-300 K, section 7 in Appendix B). As a result, PZIs also maintain high ion mobilities at low temperatures below their T_{g}. For example, the r=0.9 sample has an ionic conductivity exceeding 10⁻² mS/cm at 273 K (1000/T=3.6), orders of magnitude larger than the conductivity of PEO at the same temperature (<10⁻⁶ mS/cm)(24) (FIG. 1D).

The ionic conduction behavior of the PZI across a wide range of temperatures, including temperatures near and below T_{g}, differs from the standard, vehicular ion-conduction mechanism. The presence of superionic conduction is best indicated by the “Walden-plot” analysis shown in FIG. 1E. Traditionally, the Walden rule predicts that molar ionic conductivity (Λ≡σ/c, where c is the number density of charges in the electrolyte) is inversely proportional to the matrix viscosity(26). In viscoelastic polymers, however, it is more appropriate to consider the glassy relaxation time of the polymer, τ_{g}, rather than the viscosity. FIG. 1E demonstrates that the ‘polymeric Walden rule’ (dashed black line), though an excellent predictor of conduction for PEO and poly(propylene glycol) (PPG, another polyether), dramatically underestimates the conduction of PZIs, particularly as the polymer approaches its T_{g} (τ_{g}→100s). The Walden prediction (Λ˜Dᵢ˜τ_{g}⁻¹) is adapted from liquid-state electrolyte theory and corresponds to a conduction mechanism enabled by local fluid rearrangements. This prediction also distinguishes ‘superionic’ from ‘subionic’ conductors, where materials with conductivities exceeding the value expected from the Walden model are designated ‘superionic.’ The conductivity behavior of the PZI (τ_{g}(T), determined from rheology measurements strongly deviates from Walden predictions, with ionic conductivities at the glass transition temperature (τ_{g}(T_{g})=100 s) exceeding SPE expectations by nearly 9 orders of magnitude. This decoupling is reminiscent of inorganic solids, such as superionic ceramics (we include (Ag)_{0.5}—(AgPO₃)_{0.5}) as a reference in FIG. 1E), which suggests that the PZIs exhibit a solid-like structural motif that enables superionic behavior.

c. X-Ray Characterization

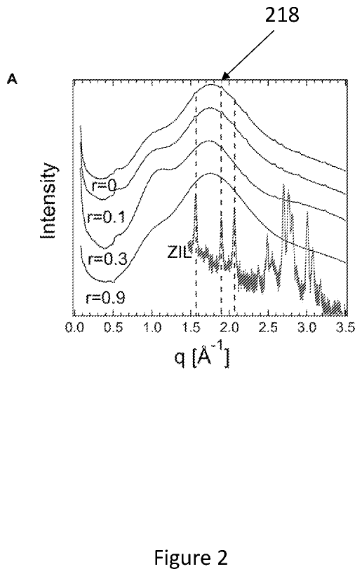

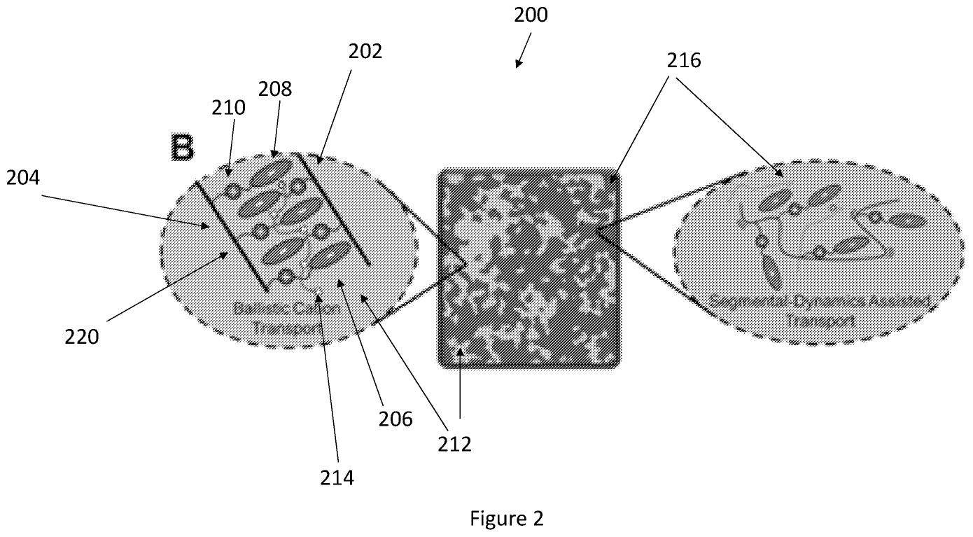

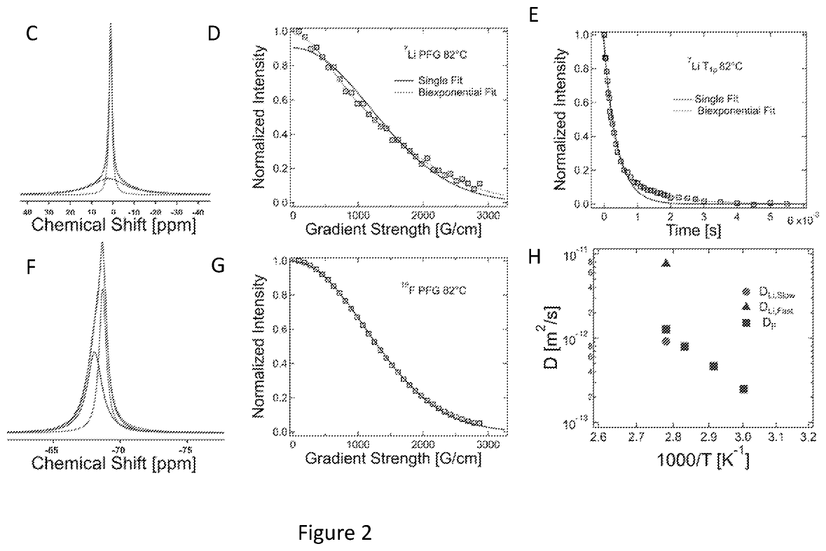

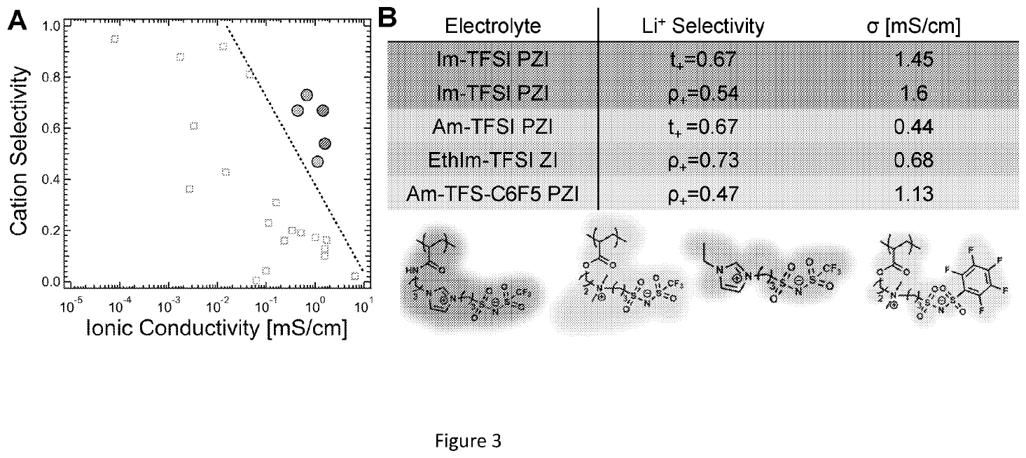

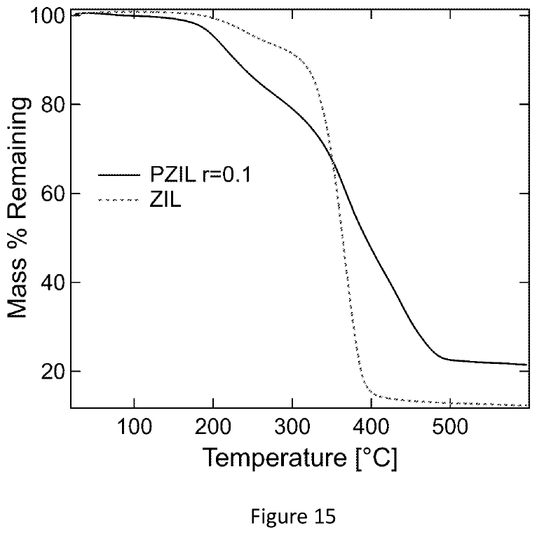

The superionic conductivity of the PZI arises from ordered regions within the electrolyte, which act as pathways for facile, size-selective ion motion. Wide angle x-ray scattering (WAXS) measurements demonstrate the presence of both ordered and amorphous features, as shown in FIG. 2A and schematically represented in 2B. The amorphous fingerprint manifests as a shouldered, broad peak ranging from q˜1-2.5 Å⁻¹. This amorphous halo reflects polymeric segment-segment correlations (27, 28). The presence of sharper Bragg reflections that are most prominent in the absence of added salt and are weak at the highest salt loading suggests a structural order arising from the zwitterionic species, likely driven by electrostatic interactions between the zwitterions. The side chain ordering in the present PZI is confirmed by comparison of the scattering pattern of the neat polymer (r=0) with that of a small molecule analog of the pendant zwitterionic groups (FIG. 3B). The structural similarity between the two crystalline structures is evident from the matching of the three primary peaks. The incomplete matching of higher-order peaks is unsurprising because the constraint of backbone attachment is likely to influence fine structural features. The similarity between the crystal structure of the small molecule analog and the polymer crystallites is further supported by thermal analysis (see FIGS. 15-17).

The X-ray data shows that these Im-TFSI based polymer electrolytes display two distinct diffusing environments, which may correspond to the ‘ordered’ and ‘amorphous’ regions of the PZI. Further ⁷Li and ¹⁹F 1D NMR, NMR relaxometry (Tip), and pulsed-field gradient NMR (section 9 in Appendix B) experiments allow atomic-scale insights into these transport environments and provide details on the supporting sub-micron diffusion processes. Significantly, in all three NMR measurements (FIGS. 2C-2H), we observe two distinct ⁷Li populations with very different dynamics. These measurements consistently show that −25% of the lithium exists in a ‘fast’ environment that relaxes and diffuses nearly an order of magnitude more quickly than the second ‘slow’ lithium population (D_{Li,fast}=7.6·10⁻¹² m²/s, D_{Li,slow}=9.2·10⁻¹³ m²/s at 358 K). Although these measurements cannot spatially distinguish motion through the amorphous and crystalline domains of the material, the presence of two lithium transport environments is suggestive of an inhomogeneous transport mechanism in which the ionic mobility of lithium is impacted by the ordered domains of the electrolyte. In contrast, ¹⁹F NMR analysis reveals a single dynamic population of fluorine, suggesting that fluorine motion is not enhanced by the polymer's dynamic heterogeneity. Due to the large size of the free TFSI⁻ anion, its motion may be hindered through the ordered regions of the electrolyte, as predicted by random barrier-type models of ion conduction (see SI Section 7).

d. Transference Conduction measurements

The performance of Li-ion batteries is ultimately dictated by the lithium-ion flux rather than by the total ionic conductivity of the electrolyte. A more complete picture of electrolyte performance, therefore, considers the selectivity of the electrolyte as well as its conductivity, with cation transport and transference numbers being two practical metrics of electrolyte selectivity (32-34). The tradeoff between permeability (conductivity) and selectivity (transference) can be captured via analogy to a Robeson plot typically used to characterize separation membranes, as shown in FIG. 3(35). Balsara et al. demonstrates a universal upper-bound on the Robeson plot (dashed line of FIG. 3A) that is independent of polymer structure and backbone chemistry(7).

As shown in FIG. 3, the Li-ion selectivity of the PZIs according to the present invention is superior to all polymer electrolytes reported to date having similar conductivities. Both the cation transport number (t₊ determined from PFG-NMR, see Section 7 in Appendix B) and the limiting current fraction (ρ₊, Section 9 in Appendix B) indicate comparable lithium selectivity at 358 K, of 0.67 and 0.54, respectively, for the PZI discussed thus far (Im-TFSI PZI). Expanding on this design strategy, other PZIs (and a small-molecule ZI) with different cation/anion pairs demonstrate similar performance, and all exceed the previously observed upper bound in the Robeson-inspired plot. The simultaneously high conductivity and lithium selectivity of the PZI suggests that engineering a solid-like and size-selective transport pathway into SPEs is a powerful strategy for outperforming the traditional ‘upper-bound’ of polymer electrolyte performance.

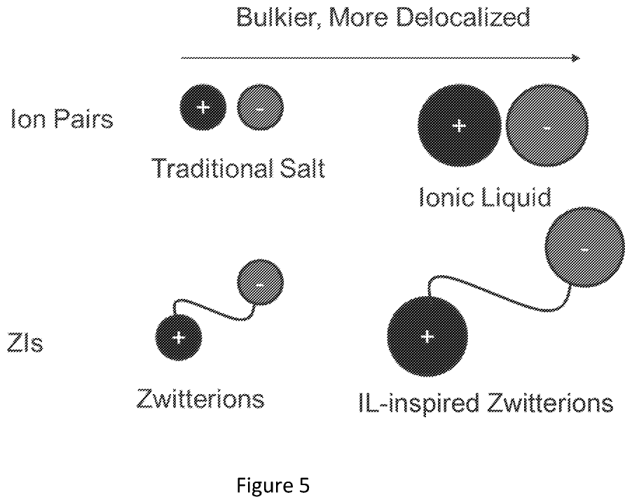

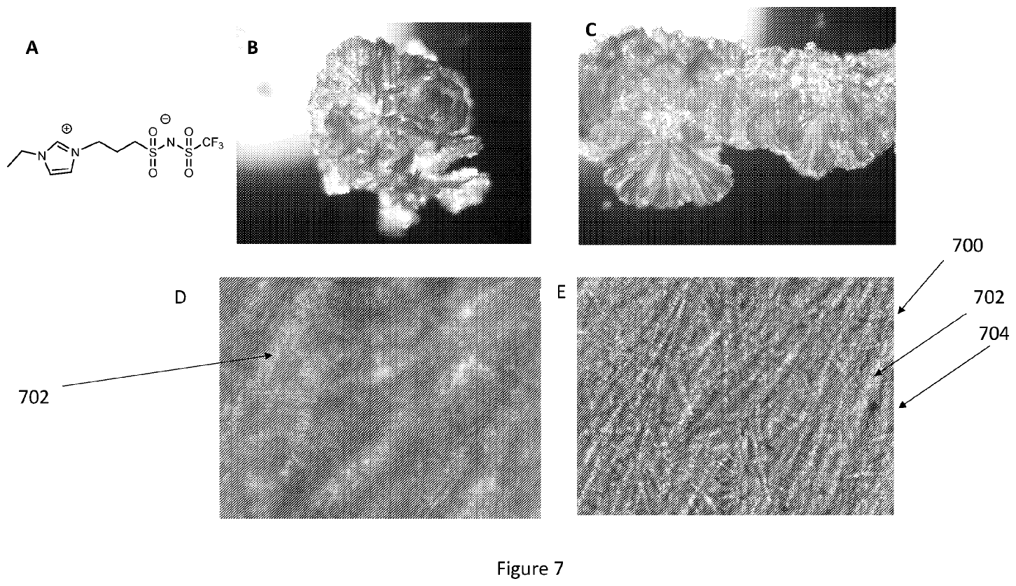

Surprisingly, a small molecule ZI with bulky imidazolium cation and trifluoromethanesulfonamide anion, which is highly crystalline at both its pristine form (FIG. 2A, FIG. 5, FIGS. 7A&B) and after blending with LITFSI (FIGS. 7C&D), showed comparable high ion conductivity (FIG. 3B) and even higher Li⁺ transport selectivity (FIG. 3B) over the PZIs, indicating superionic conduction behavior in the small molecule ZI.

e. Effect of Salt Loading on Conductivity

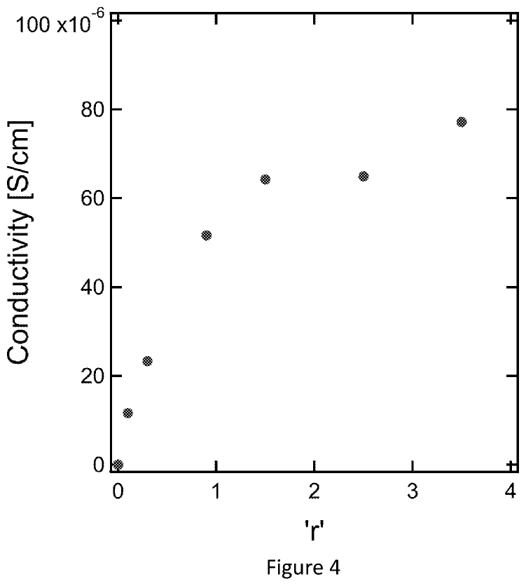

FIG. 4 illustrates higher salt/monomer ratios have been evaluated to determine the optimal formulation range for the PZIs of the first example. Although the conductivity monotonically increases throughout this composition range, the lower salt formulations may offer a better tradeoff of mechanical properties and ion conduction for some applications.

### Second Example: Electrolytes Comprising Zwitterionic Small Molecules

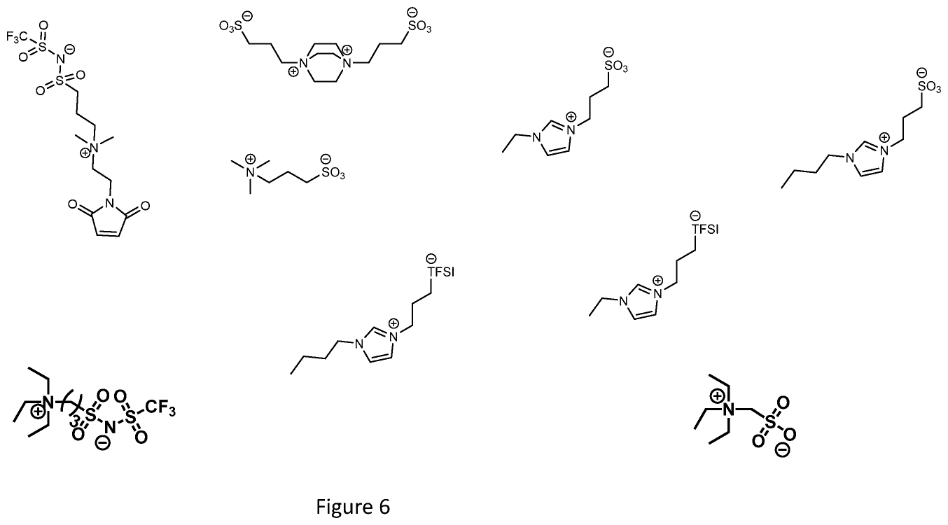

Zwitterionic molecules (e.g., small molecules) provide useful insights into their polymeric analogues and are also useful in their own right as PZI additives or as standalone electrolytes. FIGS. 5-7 illustrate example zwitterionic molecules comprising one or more anions and one or more cations that can be crystallized as a solid according to one or more embodiments described herein. A salt can be distributed through the solid so as to form a solid electrolyte conducting the alkali metal ions obtained from the salt.

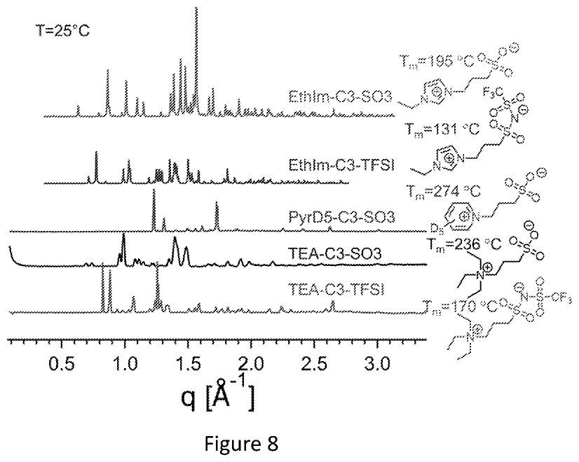

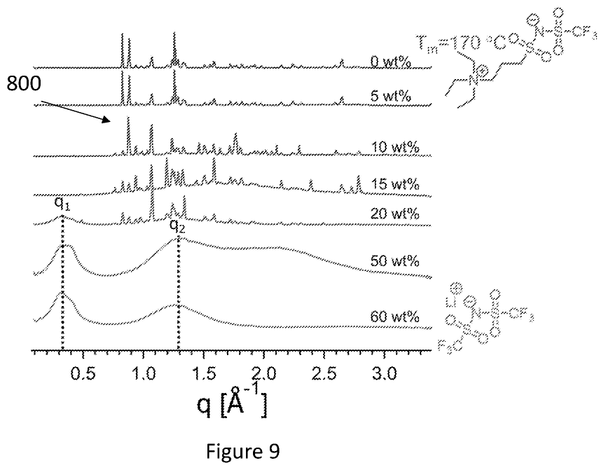

FIGS. 8-9 illustrate that a solid comprising the zwitterionic molecules comprises crystalline regions characterized by a presence of Bragg diffraction peaks in an X-ray diffraction measurement of the solid. FIG. 9 plots the measured crystallinity as a function of salt concentration and zwitterion composition, and surprisingly shows that the crystallinity can be maintained for significant salt loadings. More specifically, FIG. 9 shows that the addition of LiTFSI salt to the zwitterion molecule TEA-C3-TFSI causes a transformation from the crystal phase to a liquid-like packing at a salt loading between 20 to 50 wt % salt, defined as 100× (weight of the salt/total weight of the solid electrolyte salt and the zwitterionic molecules), wherein the salt loading at which crystallinity breaks down depends on the composition of the zwitterion and the salt (LiTFSI was tested here). Ref 38, on the other hand, suggests that addition of large amounts of salt can melt the zwitterion and greatly reduce its total crystallinity.

Crystallinity can be increased by reducing spacing between the anion and the cation in each zwitterion (3-4 carbon spacing produces a solid with very crystalline zwitterions), eliminating steric bulky groups, and/or reducing ion size. Generally, the melting temperature of the constituent ionic liquid has some correlation with the melting temperature of the constituent zwitterion, so ions that produce traditional high-melting salts will be more highly crystalline than Ionic liquid type ions. However, as described above, the crystalline structure also requires appropriately sized void spaces allowing passage and conduction of the alkali metal ions while also blocking passage of undesired ions that do not contribute to conduction. In one or more embodiments, the void spaces have a largest diameter of at least 200 picometers, or in a range of 200 picometers-1 nanometer.

In one or more examples, optimal or maximal alkali metal ion conduction is not achieved with maximized crystallinity, but rather is tradeoff between a synthesis having some crystallinity while also producing the void spaces having adequate dimensions. For example, in one or more examples, the solid electrolyte comprises a structure that ‘just barely’ crystallizes, or the electrolyte is engineered with the maximum salt concentration before de-crystallization occurs.

The above described structural considerations for zwitterionic molecules also apply for the design of the pendant side chains in PZIs. In some embodiments, the polymer in the PZI should not be crosslinked and should be thermally processed above its Tg but below the Tm of the crystal. In one or more examples, the spacing of the zwitterion groups in the pendant side chains should be regular, or an alternating structure can also be used. In this regard, selection of the monomer in the pendant side chains may be critical to provide the proper spacing or regularity of the anions and cations along the side chain.

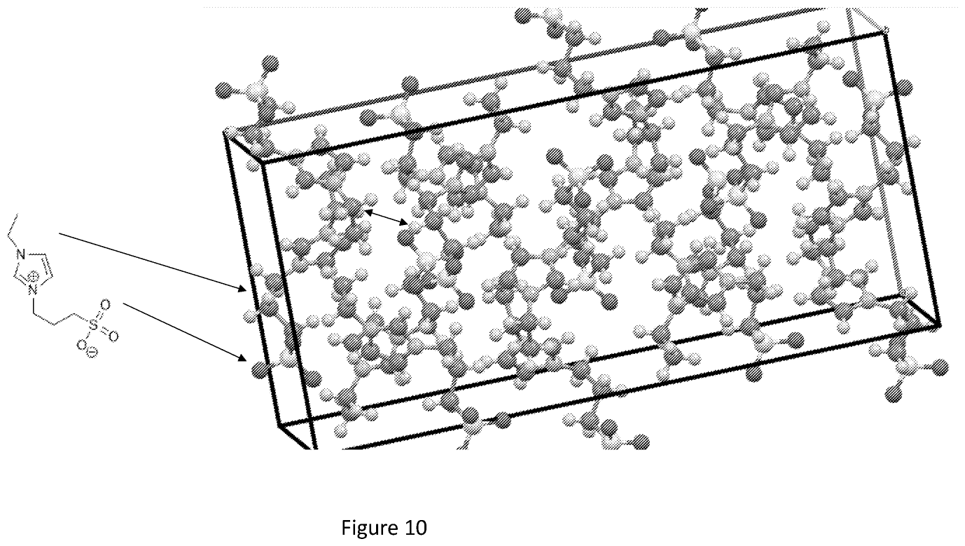

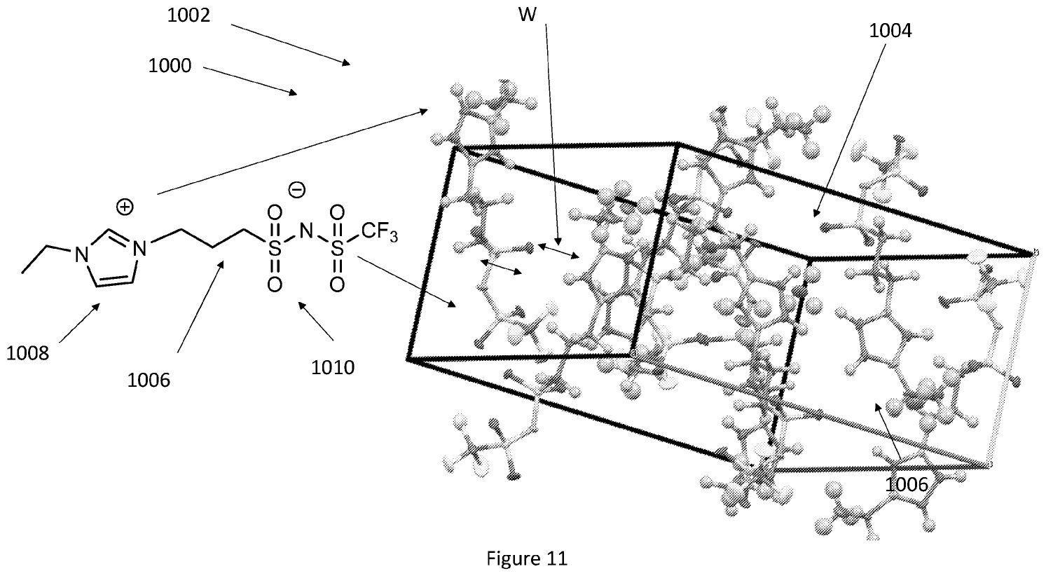

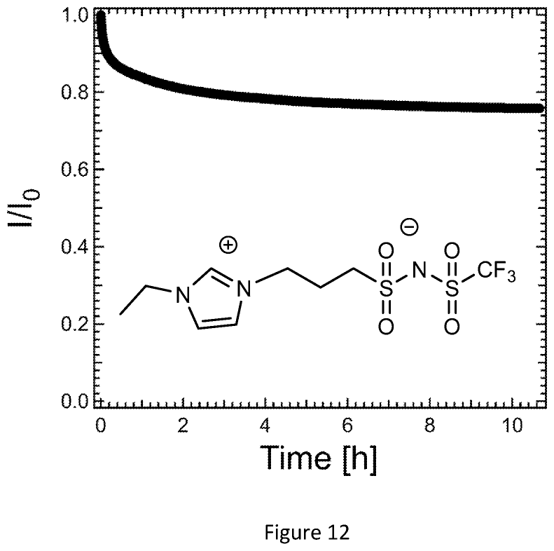

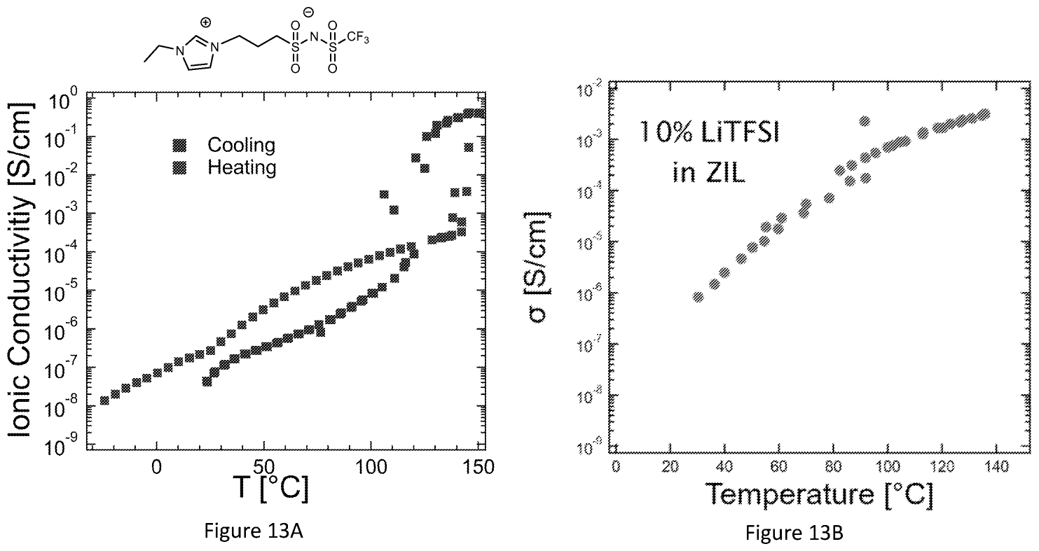

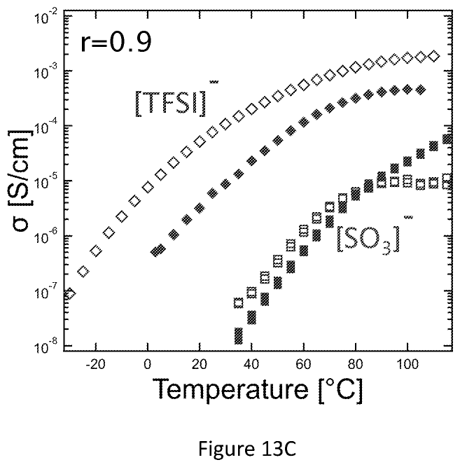

FIGS. 10-11 illustrate example solid electrolyte 1000 comprising a crystalline structure 1002 (derived using the X-ray diffraction data) and void passages 1004 between the zwitterions 1006. FIG. 10 is a lower conductivity example (as compared to FIG. 11) because the void spaces are smaller in FIG. 11. FIGS. 12 and 13 illustrated the conductivity properties of an example crystalline solid electrolyte comprising a small molecule zwitterion.

### Third Example: Mechanical Properties

a. Rheological Measurements

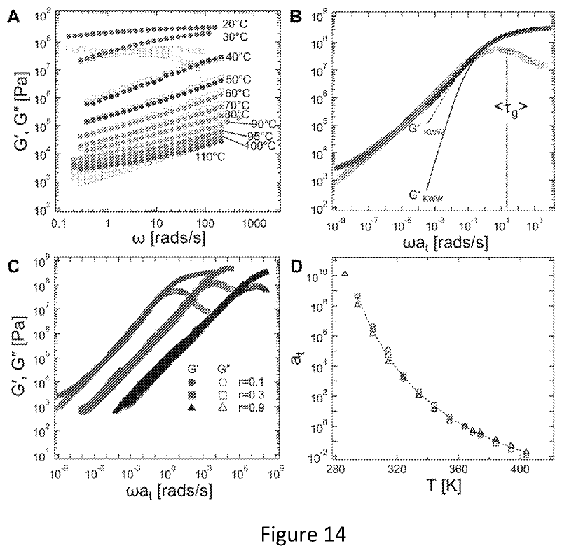

FIG. 14 illustrates rheological measurements were made on an ARES-G2 strain-controlled rheometer manufactured by TA instruments. Stainless steel 8 mm parallel plates were used for all measurements. Samples were prepared for rheology by compression molding into a disc mold before loading. Rheology samples were further compressed at 70° C. and 5N of force on the rheometer instrument. During operation all samples were enclosed in a nitrogen-purged oven chamber. Final sample thicknesses were maintained within a range of 0.3-0.5 mm. All measurements were made in the ‘linear regime’ as determined via strain sweep measurements. Temperature-dependent frequency measurements were performed as a sequence of experiments with 5 minutes of soak time between steps. To investigate long-time responses of the materials a stress relaxation experiments was also performed, however the terminal region could not be located.

Since the structural relaxation rate generally plays a critical role in dictating the ionic conductivity of an electrolyte, it is useful to evaluate the ionic conduction performance of a material in the context of its structural relaxation rate. Frequently, the calorimetrically-determined glass transition temperature is the sole metric of polymer dynamics and ionic conductivity is classified in terms of the temperature difference from T_{g} i.e. ‘T−T_{g}’. This simplistic treatment of polymer dynamics is insufficient for fundamental studies of ion conduction as it cannot account for the nonlinear temperature dependence of polymer dynamics. Consequently, it is important to contextualize ion dynamics in terms of measured ion dynamic timescales.

Linear viscoelastic measurements are a robust means of assessing the temperature-dependence of polymer dynamics. FIG. 14A shows individual frequency sweeps at small oscillatory strains of the r=0.1 PZI at various temperatures. Transformation of these curves by time-temperature superposition (TTS) yields the master curve shown in FIG. 14B. Although TTS does not rigorously apply to thermo-rheologically complex materials, these master curves are nonetheless useful in determining dynamics over a broad range of frequencies. The master curve in FIG. 14B displays typical glassy behavior at high effective frequencies (ωa_{T}) with a plateau in the storage modulus in the gigapascal regime and a local maximum in the loss modulus. This glassy regime was fit by the Kohlrausch-Williams-Watts (KWW) expression for the time-dependent modulus G(t) (Equation 1), a common phenomenological model for the glassy relaxation of polymers, which has been expressed in terms of its first moment, τ_{g}, corresponding to the average timescale of segmental rearrangement (note: fitting was performed in frequency space as described in (36), fitting utilized the ‘libkww’ library which provides an approximation for the Fourier transform of stretched exponential functions(2)). The ‘β’ parameter in this expression corresponds to the breadth of the glass transition, approaching unity in the case of a uniform relaxation and broadening as it approaches zero. The reference temperature in Equation 1 is the same as the reference temperature used to generate TTS curves (30° C.). This glass transition is followed at longer effective times by a collective relaxation with scaling behavior G′≈G″ ˜ω^{0.5} and finally, a long-lived plateau that is confirmed by stress relaxation experiments (Section S11 in Appendix B). This relaxation scaling behavior and plateau is consistent with a percolated network of ionic crosslinks that results in long-lived elastic behavior (37), though detailed analysis of the viscoelastic behavior of the system is beyond the scope of this study.

$$G ( t , T = {T}_{ref} ) = {G}_{g} ( 0 ) exp [ - {( \frac{t Γ ( {β}^{- 1} )}{{τ}_{g} ( {T}_{ref} ) β} )}^{β} ] \qquad Eqn . 1$$

This construction and fitting of the master curves (FIG. 14C) enables determination of the segmental relaxation timescale and its temperature dependence, τ_{g}(T), which is critical in understanding the overall polymer dynamics. Equation 2 illustrates the procedure used to generate the τ_{g}(T) function where a_{T}(T) corresponds to the shift factor functions in FIG. 14D. These functions are used to generate the Walden plot (FIG. 1E).

$${τ}_{g} ( T ) = {τ}_{g} ( {T}_{ref} ) {a}_{T} ( T ) \qquad Eqn . 2$$

b. Thermogravimetric Analysis

FIG. 15 illustrates thermogravimetric analysis (TGA) performed on the materials of the first example and second example to monitor their thermal stability and to confirm removal of volatiles. TGA was performed using a TA instruments Discovery TGA with an aluminum hangdown pan and an Aluminum oxide crucible. Sample masses of ˜2 mg were loaded into pre-tared crucibles in an air environment. The samples were exposed to a thermal ramp of 10° C./minute from room temperature to 600° C. under an inert nitrogen atmosphere.

The data shows the PZI and zwitterionic molecules are stable up to at least 180 degrees Celsius, allowing melt processing of the electrolyte.

c. Differential Scanning Calorimetry

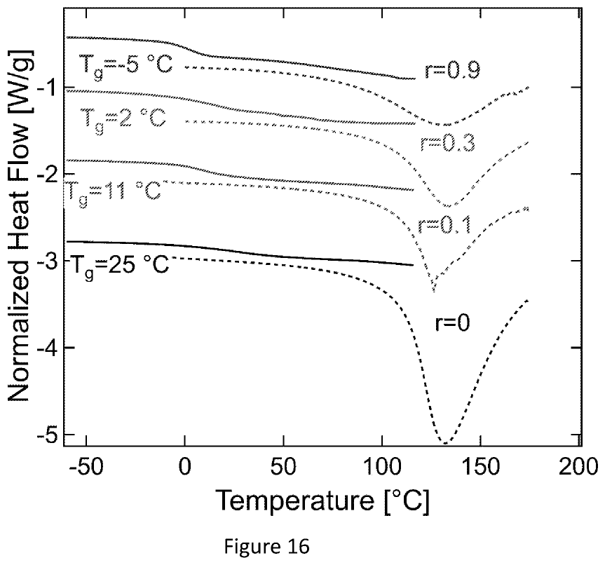

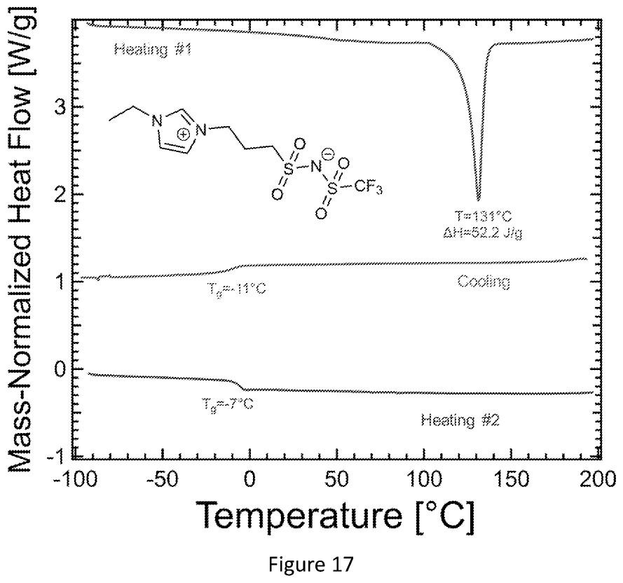

FIGS. 16-17 illustrate differential scanning calorimetry (DSC) measurements of an example solid electrolyte comprising a PZI (FIG. 16) and a small molecule zwitterion (FIG. 17) and performed on a TA Instruments DSC 2500. Approximately 6 mg of each sample was weighed and loaded into aluminum ‘Tzero’ pans with hermetically sealed lids. All samples were heated to 160° on an initial heating cycle and cooled to −80° C. Glass transition measurements were recorded on the second heating cycle at a ramp rate of 20° C./minute. The glass transition temperature was analyzed via the midpoint analysis method.

### Third Example: Siloxane-Based PZIs

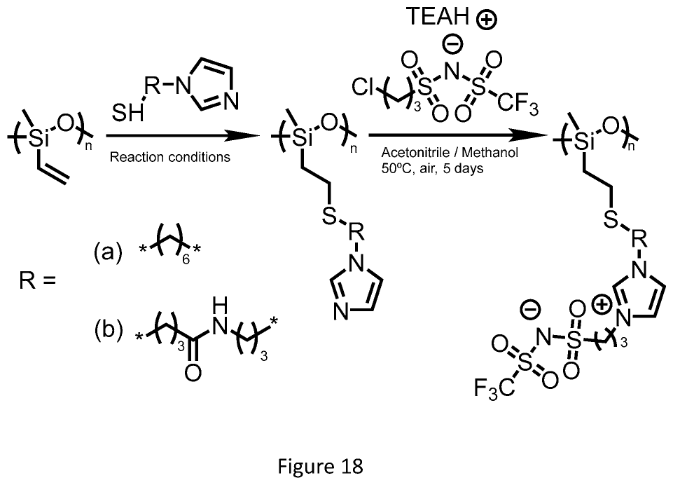

In some applications, electrochemical stability and ion motion of the PZIs for practical operation of cells may be enhanced using siloxane based PZIs. FIG. 18 illustrates a synthetic scheme for the synthesis of siloxane PZIs. Siloxane based PZIs can withstand larger potential windows for more charge/discharge cycles before degradation compared to the acrylic PZIs. Many variations of these siloxane based PZIs are possible including, but not limited to, removal of the amide group and polymerization termination with different chain ends.

### Fourth Example: Block Copolymer PZIs

The heterogeneous mechanism for conductivity within PZIs according to the first and second examples suggests that a block copolymer PZI can be structured at multiple length scales, including mesoscale ordering, orientation and connectivity of the crystalline domains, so as to tailor macroscopic-scale ion mobility, high ionic conductivity, selectivity for lithium, and the elastic modulus of the polymer. Moreover, in one or more examples, the mesoscale structure can be selected to modify crystallization behavior within a PZI block, e.g., nanoconfinement of the PZI regime during crystallization could increase the connectivity of superionic crystals, thereby improving conductivity.

In one or more examples, the block copolymer PZI comprises a conducting block and a glassy insulating block configured to realign and confine conducting domains at the mesoscale, while also imparting additional mechanical rigidity through the glassy regions of the polymer.

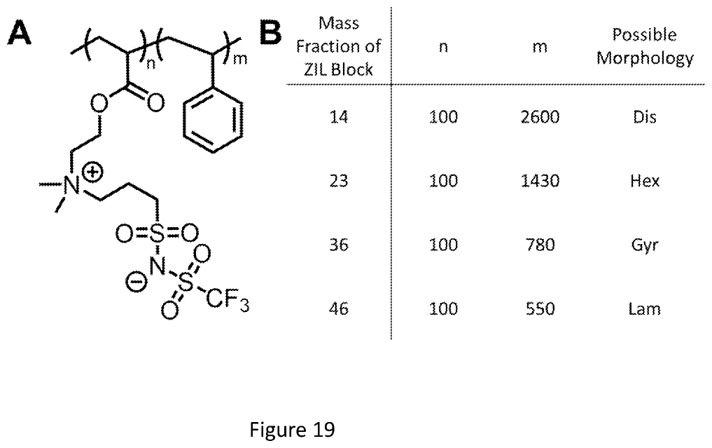

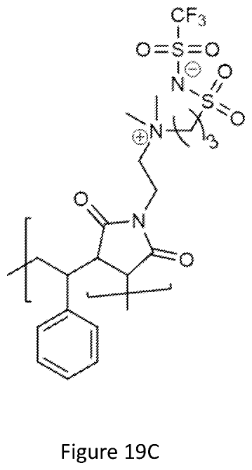

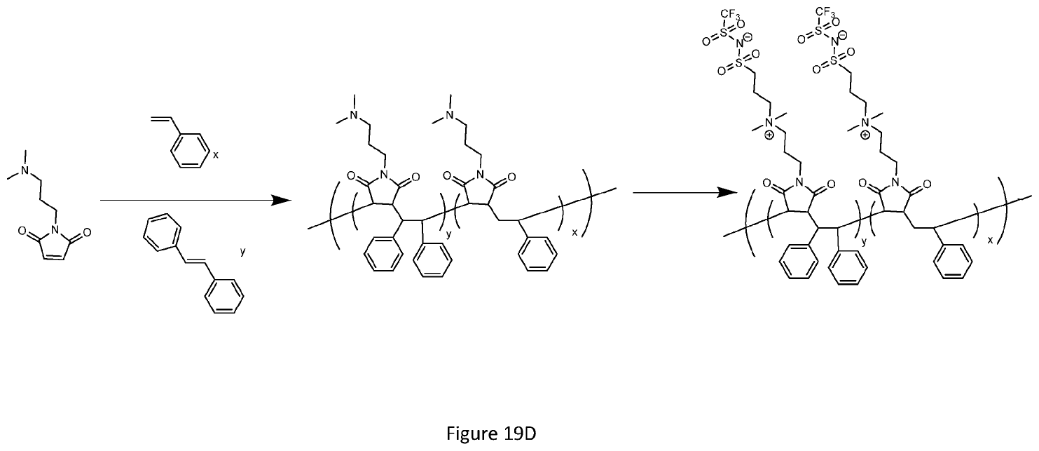

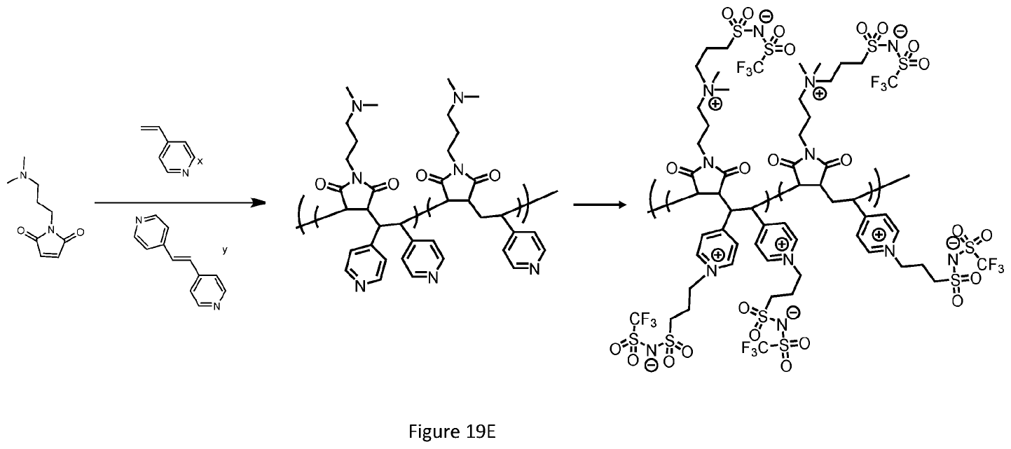

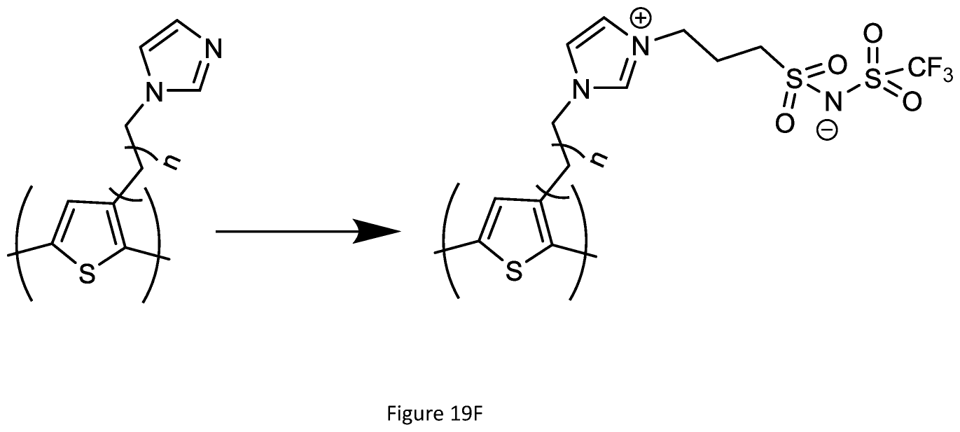

FIG. 19A illustrates synthesized diblock copolymers of polystyrene (PS) and an acrylic PZI with ammonium counterions and TFSI-like anions. Synthesis of materials to map the phase diagram for this material system enables the design of PZIs with desirable morphologies, such as double gyroid and hexagonally packed cylindrical phases. FIG. 19B illustrates mapping the ternary phase space, wherein four block copolymers have been synthesized with a variety of block fractions ranging from 14 to 46% PZI by mass and doped at salt loadings from r=0 to r=2. Morphology of these block copolymers, including mesoscale ordering, may be observed using X-ray scattering experiments.

FIG. 19C illustrates a polymer with an alternating zwitterionic structure that could also be synthesized as a solid electrolyte.

Rigid backbones crystallize more readily and create crystallites with longer spatial correlations. FIG. 19D illustrates a polymer with controlled backbone rigidity, wherein uniform charge spacing is enforced by alternating the composition backbone and stiffness can be controlled by the ratio of styrene to stilbene. FIG. 19E illustrates a polymer embodiment wherein the styrenes are replaced with pyridines so as to increase ZI loading and break the uniform spacing on one side. In other examples, polymers with imidazole pendant polythiophenes can very conveniently be converted to zwitterionic species, allowing parallel paths for electron and ion conduction (FIG. 19F).

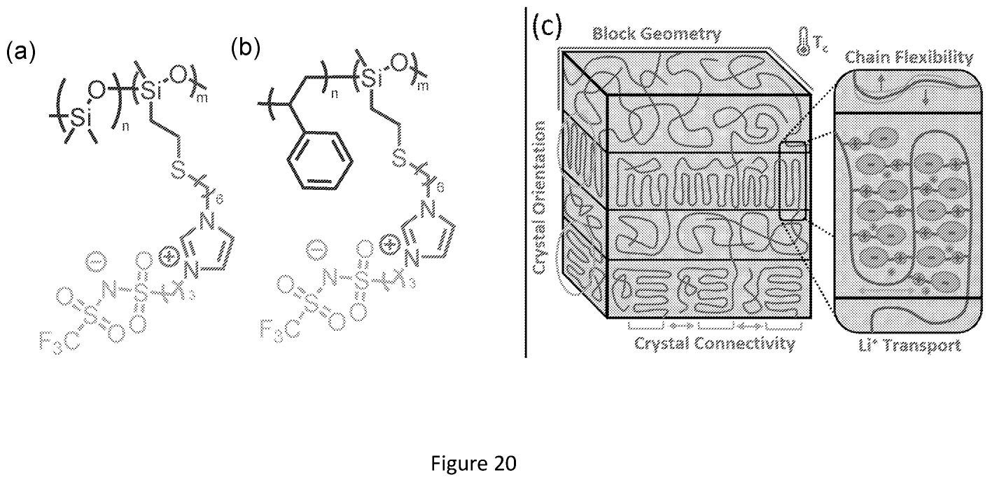

FIG. 20 illustrates an example comprising diblock copolymers of siloxane PZI with imidazolium counterions, TFSI-like anions, and one of two types of nonconducting secondary blocks. In one or more examples, these polymers can be synthesized via anionic polymerization of cyclic dimethyl siloxane (DMS, FIG. 20a) or styrene (FIG. 20b) with cyclic vinyl methyl siloxane (VMS), and subsequently modified to form zwitterions. A stiff PS block should induce “hard” confinement on the PZI during crystallization, whereas a flexible PDMS block should induce “soft” confinement. BCPs can be synthesized with varying block mass fractions to span spherical, cylindrical, and lamellar mesoscale morphologies. PZIs can be isothermally crystallized at temperatures (T_{c}) ranging from glass transition (T_{g}) to melt (Tₘ) in order to determine the effect on crystal orientation and connectivity. Thus, secondary block stiffness, block copolymer geometry, and processing temperature can be tuned to optimize Li⁺ transport.

### Fifth Example: Process Steps

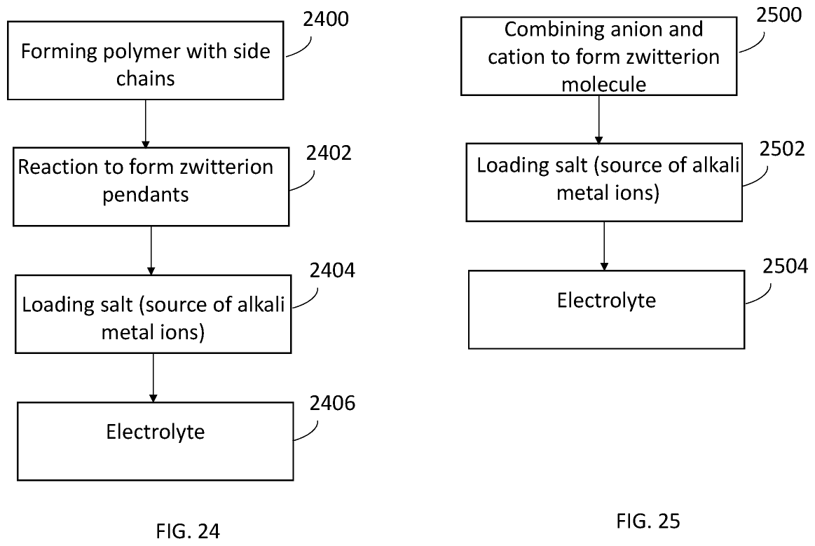

FIG. 24 is a flowchart illustrating a method of synthesizing a solid electrolyte comprising a PZI according to one or more examples.

Block 2400 represents obtaining or synthesizing a polymer comprising a backbone and side-chains attached to the backbone. In one or more examples, a monomer attached to one or more zwitterionic units is synthesized and then subsequently polymerized to form a polymer comprising side chains comprising the zwitterionic units. In another example, the side-chain comprises a charge neutral moiety that can be converted to an anion or cation by reaction with a zwitterionic salt using step 2402.

Block 2402 represents optionally combining the polymer with the zwitterionic salt comprising a cation (when the charge neutral moiety comprises an anion precursor) or an anion (when the charge neutral moiety comprises a cation precursor), so as to form a PZI. The anion precursor or cation precursor is converted to an anion or cation by reaction with the zwitterionic salt (see e.g., the synthetic method section. For example, when the charge neutral moiety is an imidazole or amine before reacting with the zwitterionic salt, the charge neutral moiety becomes imidazolium or an ammonium cation after reaction with the zwitterionic salt. Block 2404 represents loading the PZI with an electrolyte salt comprising the alkali metal ion (e.g., lithium) under conditions so as to form a solid crystalline electrolyte. In one or more examples, the step comprises solution casting, comprising combining the PZI with the salt in a solvent so as to form a solution, and heating the solution so as to evaporate the solvent and form the solid crystalline electrolyte. In yet another example, the step comprises melt processing, wherein a sample comprising a combination of the PZI and salt is subjected to a compressive force that melts the sample which is then cooled to form the solid electrolyte. In one or more examples, the temperature during the loading step (evaporation step during solution casting or temperature during melt processing) is above Tg of the polymer but below the Tm of the solid electrolyte. In various examples, the Tg of the polymer is at room temperature.

Block 2406 represents the end result, a solid electrolyte comprising the PZI.

FIG. 25 is a flowchart illustrating a method of synthesizing a solid electrolyte comprising a Zwitterion small molecule according to one or more examples.

Block 2500 represents obtaining or synthesizing a molecule comprising a zwitterion.

Block 2502 represents loading the zwitterion molecule with a salt comprising the alkali metal ion (e.g., lithium) under conditions so as to form a solid crystalline electrolyte. In one or more examples, the step comprises solution casting, comprising combining the zwitterion molecule with the salt in a solvent so as to form a solution, and heating the solution so as to evaporate the solvent and form the solid crystalline electrolyte. In yet another example, the step comprises melt processing, wherein a sample comprising a combination of the zwitterion molecule and salt is subjected to a compressive force that melts the sample which is then cooled to form the solid electrolyte. In one or more examples, the temperature during the loading step (evaporation step during solution casting or temperature during melt processing) is below the Tm of the solid electrolyte.

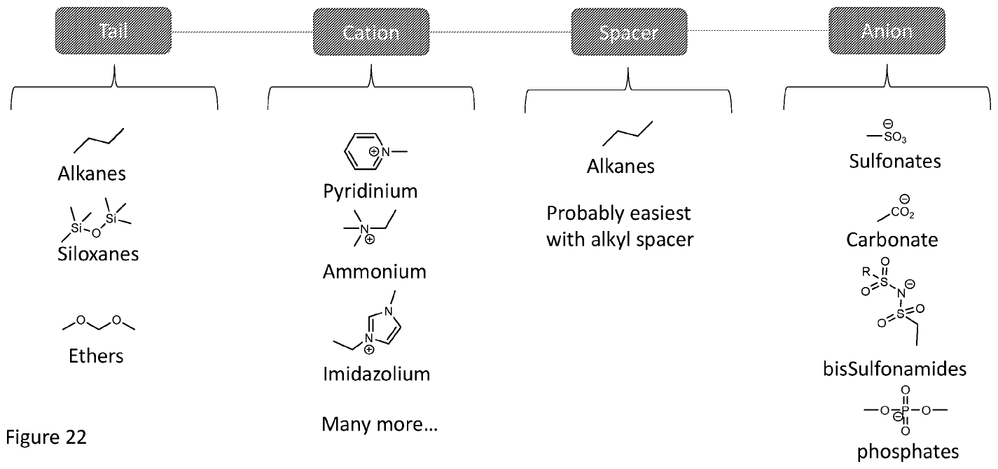

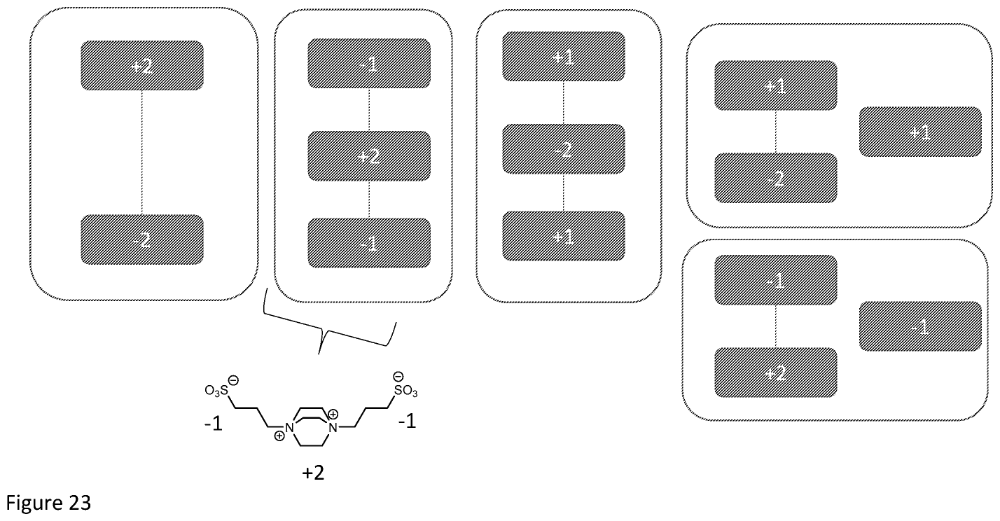

Block 2504 represents the end result, a solid electrolyte comprising zwitterionic molecules (referring also to FIGS. 1-25).

Illustrative embodiments of the inventive subject matter include, but are not limited to, the following.

1. A solid electrolyte 1000, 700, 200 comprising (referring to e.g., FIG. 1, FIG. 2, FIG. 3, FIG. 7, FIG. 9, and FIG. 11):
a solid 1000, 200 comprising zwitterionic compounds each comprising one or more cations 1008, 210 and one or more anions 1010, 208, the zwitterionic compounds comprising at least one of zwitterionic molecules 1006 or charge neutral polymers 204 comprising zwitterion pendants 206; and
an electrolyte salt 212, 702, 100 distributed through the solid such that the solid conducts the alkali metal ions 102, 214 obtained from the salt and the zwitterionic compounds each include zero or more amorphous regions 216 and one or more crystalline regions 202, 1002, 704 characterized by:
a presence of Bragg diffraction peaks 218, 800 in an X-ray diffraction measurement of the solid; and
the solid optionally having an ion conductivity of at least 10⁻⁴ S/cm at a temperature of 50 degrees Celsius (see e.g., FIG. 1D) when:
a molar ratio r of the salt to the zwitterionic monomer units in the charge neutral polymers is 0.9 (or optionally 0.9 or less) and optionally when the molar ratio r of the salt to the zwitterionic units in the zwitterionic molecules is 0.9 (or optionally 0.9 or less).

2. The solid electrolyte of example 1, wherein the solid comprises a blend of the zwitterionic molecules and the charge neutral polymers.

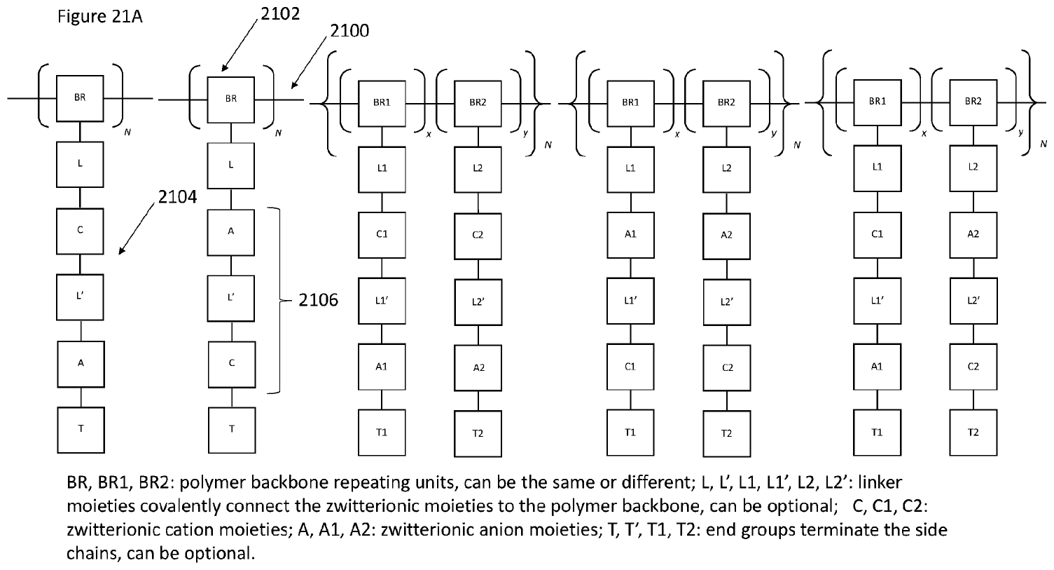

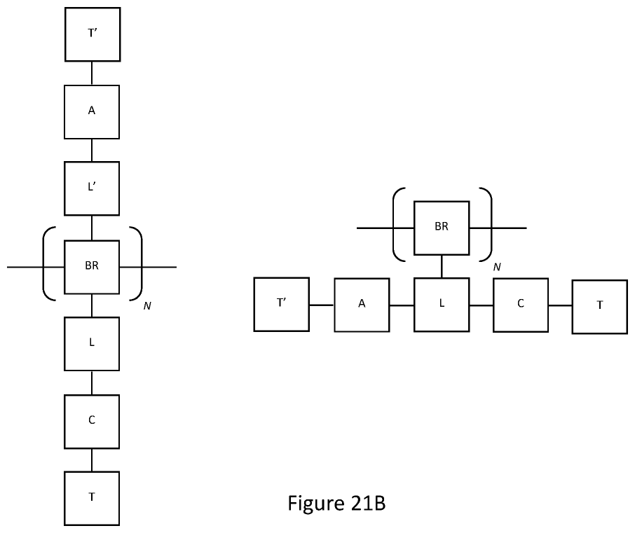

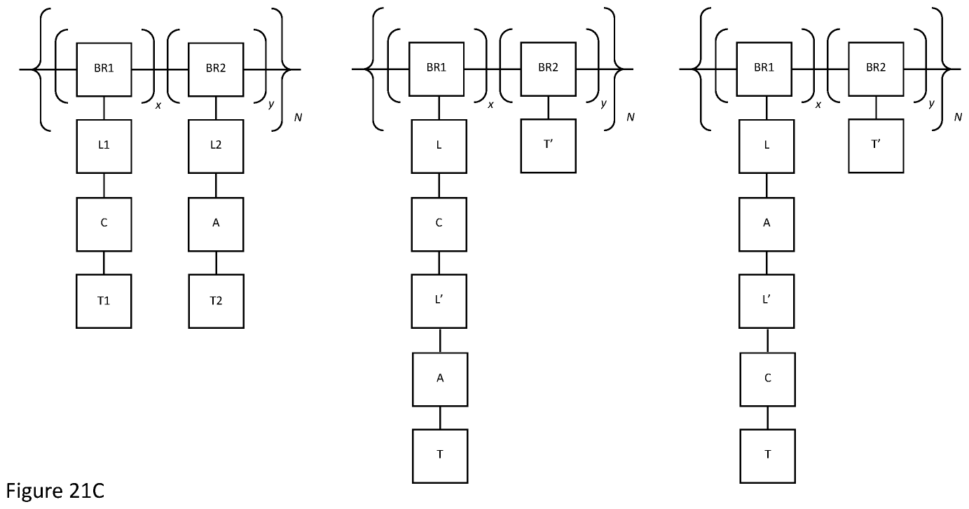

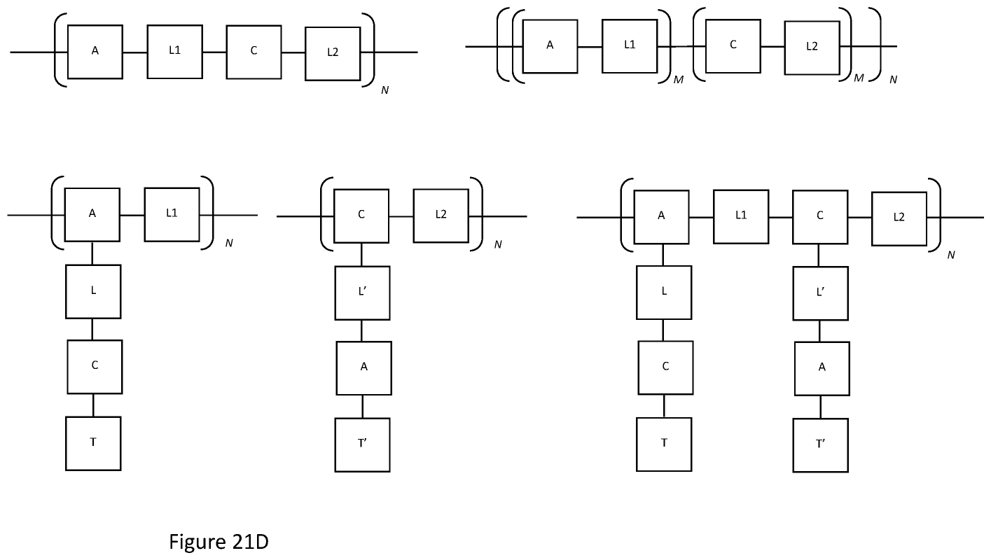

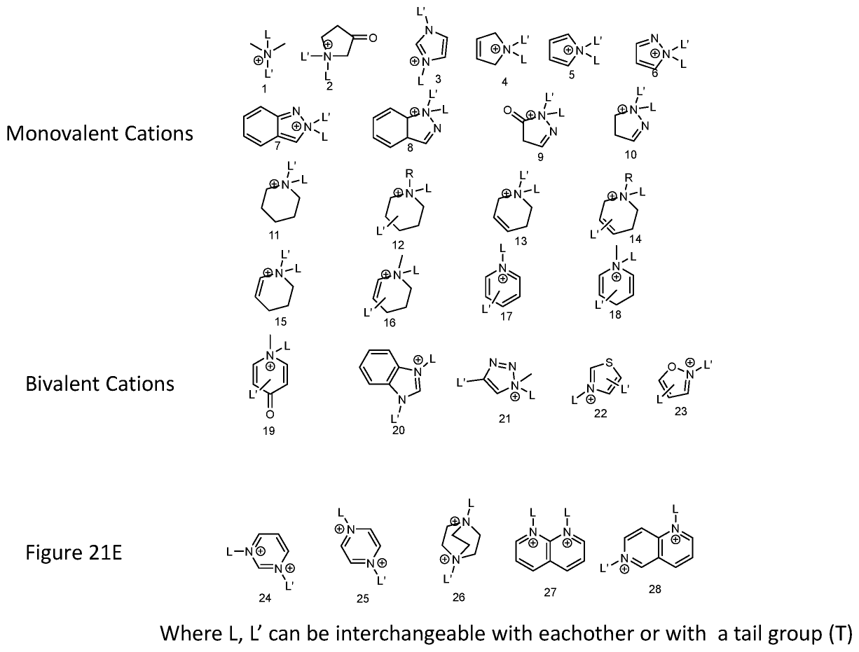

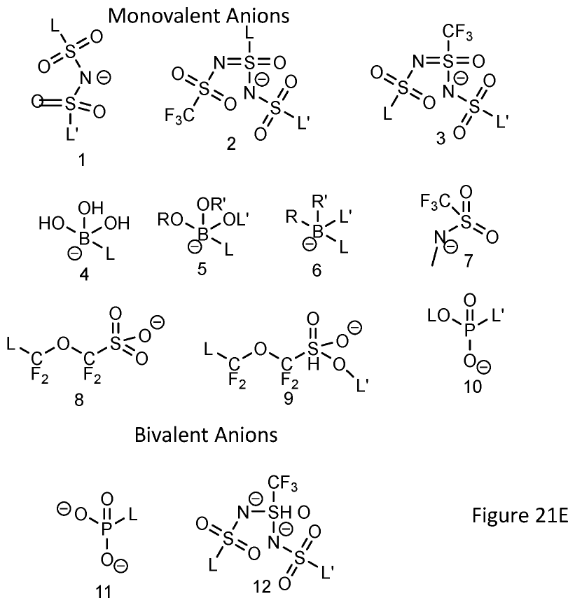

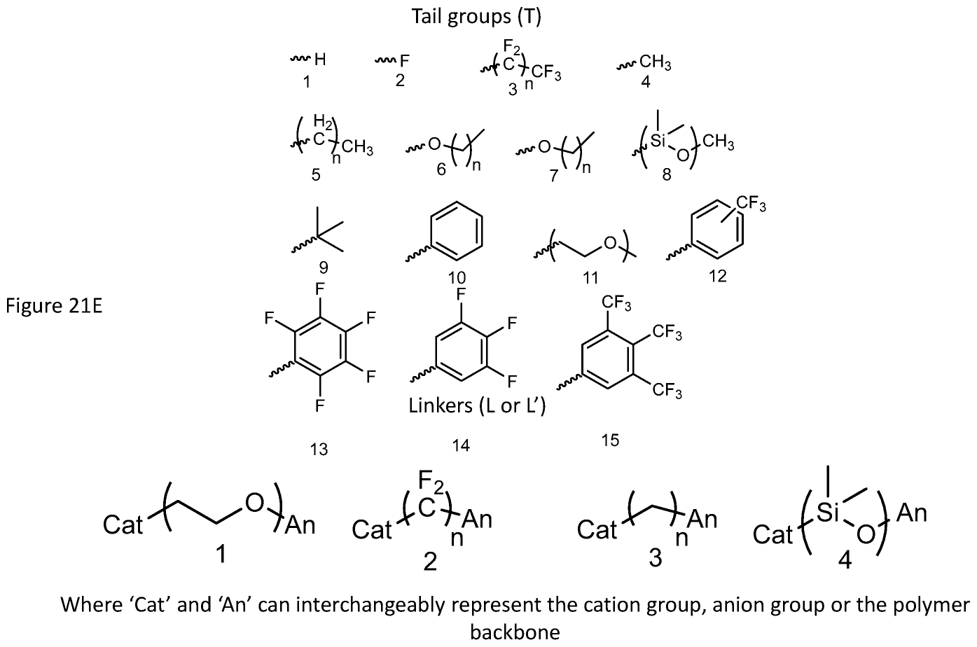

3. The solid electrolyte of any of the examples 1-2, wherein the charge neutral polymers each comprise (see e.g., FIG. 2 and FIG. 21):
a backbone 2100, 220 comprising a plurality of backbone monomers 2102; and
a plurality of side chains 2104, each of the side-chains attached to one of the backbone monomers, wherein:
at least one of the side chains each include at least one of the zwitterionic monomer units 2106 comprising at least one of the cations and at least one of the anions of compensating charge; and
the charge neutral polymers comprise one or more of the crystalline regions 202 and one or more of the amorphous regions 216.

4. The solid electrolyte of any of the examples 1-3, wherein:
the zwitterionic molecules 1006 each comprise one or more of the cations 1008 and one or more of the anions 1010; and
the zwitterionic molecules are located in one or more of the crystalline regions 704.

5. The solid electrolyte of any of the examples, wherein the cations and the anions have sizes and shapes so that the crystalline regions include, or are separated by void spaces 1004 or vacancies or pores, or pathways sufficiently large to selectively allow passage of the alkali metal ions 102 through the voids or vacancies such that the solid conducts the alkali metal ions with the transport number of at least 0.5.

6. The solid electrolyte of any of the examples 1-5, wherein the alkali metal ions 102 are preferentially transported through the crystalline regions 202, 704 that form a percolation path through a surrounding matrix comprising the material of the solid 200, 1000, 700 (e.g., matrix comprising the zwitterionic compounds).

7. The solid electrolyte of any of the examples 1-6, wherein the solid is not cross-linked and thereby remains soluble and/or melt processible.

8. The solid electrolyte of any of the examples 1-7, wherein the crystalline regions 202, 704, 1002 are arranged and dimensioned such that a conduction of the alkali metal ions is characterized by ballistic transport in a crystal.

9. The solid electrolyte of any of the examples 1-8, wherein the solid is characterized by a linear elastic modulus of at least 100 kilopascals at room temperature (30 degrees Celsius) under a deformation frequency of 0.1 Hz (see e.g., FIG. 14).

10. The solid electrolyte of any of the examples 1-9 wherein the molar ratio r is in a range 0.05≤r≤2.

11. The solid electrolyte of any of the examples 1-10, wherein:
the crystalline regions are dimensioned and arranged such that the solid has the ion conductivity of at least 10⁻⁴ S/cm at a temperature 30 of degrees Celsius, and
the transport number for the alkali metal ions is at least 0.5 (see e.g., FIG. 1D).

12. The solid electrolyte of any of the examples 1-11, wherein:
the crystalline regions are dimensioned and arranged such that the solid has the ion conductivity of at least 10⁻⁶ S/cm at a temperature −15 degrees Celsius (see e.g., FIG. 1D), and
the transport number for the alkali metal ions is at least 0.5.

13. The solid electrolyte of any of the examples 1-12, wherein:
the crystalline regions are dimensioned and arranged such that the solid has the ion conductivity of at least 10⁻⁵ S/cm at a temperature 0 degrees Celsius (see e.g. FIG. 1D), and
the transport number for the alkali metal ions is at least 0.5.

14. The solid electrolyte of any of the examples 1-13, wherein the alkali metal ions are lithium ions, zinc ions, magnesium ions, copper ions, sodium ions, potassium ions, or calcium ions.

15. The solid electrolyte of any of the examples 2-14, wherein:
the side chains have a regular or periodic spacing along the backbone; and
the cations and anions are sufficiently bulky to allow formation of a free volume between the side chains, the free volume so dimensioned to allow transport of the alkali metal ions through the free volume.

16. The solid electrolyte of any of the examples 1-15, wherein:
the side-chains each have an alkyl, ethylene, or siloxane linker connecting the zwitterionic monomer to the backbone, and
the linker has a length in a range of 1-30 atoms so as to allow crystallization of the side chains.

17. The solid electrolyte of any of the examples 1-16, wherein the cation comprises an imidazole or imidazolium and the anion comprises a trifluoromethanesulfonimide (TFSI, —SO₂N⁻SO₂CF₃), or —SO₂N⁻SO₂—.

18. The solid electrolyte of any of the examples 1-17, wherein the cation comprises an ammonium and the anion comprises a trifluoromethanesulfonimide (TFSI, —SO₂N⁻SO₂CF₃), or —SO₂N⁻SO₂—.

19. The solid electrolyte of any of the examples 1-18, wherein the charge neutral polymer has one of the structures shown in FIGS. 21A-21D,
wherein:
BR, BR1, BR2 are the backbone monomers,
the cation comprises C, C1, or C2,
the bivalent anion comprises A, A1, A2,
the side-chains comprise L, L′, L1, L1′, L2, L2′ comprising aliphatic linker moieties covalently connecting the zwitterionic monomers to the backbone monomers, and
T, T′, T1, T2 comprise end groups terminating the side chains.

20. The solid electrolyte of any of the examples 2-19, wherein the backbone comprises a polysiloxane backbone, a polyolefin backbone, a polystyrene backbone, a polyacrylate backbone, a polymethacrylate backbone, or a vinyl polymer backbone

21. The solid electrolyte of any of the examples 1-20, wherein the solid comprises a blend comprising the zwitterionic compounds and an additive, binder, or additional component.

22. The solid electrolyte of example 21, wherein the additive or additional component comprises a nucleating agent or a component enhancing the crystallinity of the crystalline regions or mechanical properties of the solid.

23. The solid electrolyte of any of the examples 1-22 wherein the one or more crystalline regions comprise one or more smectic crystals.

24. The solid electrolyte of any of the examples 1-23 comprising crystallographic disorder.

25. The solid electrolyte of any of the examples 1-24, wherein the zwitterionic compounds comprise the zwitterionic molecules but not the charge neutral polymers.

26. The solid electrolyte of any of the examples 1-25, wherein the solid has been crosslinked during or after solution or melt processing to enhance its mechanical performance.

27. The solid electrolyte of any of the examples 1-26, wherein an ionic conductivity of the electrolyte in the absence of the salt is <10⁻¹¹ S/cm or <10⁻¹⁰ S/cm so that a majority of the conductivity comprises the conductivity of the alkali metal ions.

28. The solid electrolyte of any of the examples 1-27, wherein the transport number t⁺ is defined as the proportion of the ion conductivity which arises from the alkali metal ions and if the relative concentration of anions and cations are equal, then the transport number can be determined as follows:

$${t}_{+} = \frac{{σ}_{+}}{{σ}_{+} + {σ}_{-}}$$

where σ₊ is a first component of a conductivity of the solid electrolyte arising from the alkali metal ions (cations) and σ₋ is a second component of the conductivity attributed to any other ions different from the alkali metal ions, including anions.

29. The solid electrolyte of any of the examples 1-28, comprising a solid polymer electrolyte.

30. The solid electrolyte of any of the examples 1-29, wherein the crystalline regions are three dimensional and a percolation path for conduction of the alkali metal ions through the solid extends in 3 dimensions.

31. The solid electrolyte of any of the examples 1-30, wherein a zwitterionic salt comprised of the tethered cation and the anion, when separate from the zwitterionic compounds, has a melting temperature below 100 degrees Celsius.

32. The solid electrolyte of any of the examples 1-31, wherein the anions are ionic liquid like or are larger than anions comprising SO₃.

33. A battery comprising the solid electrolyte of any of the examples 1-32 in contact with an anode and a cathode.

34. The solid electrolyte of any of the examples 1-33 having any of the structures shown in FIG. 21, wherein N, x, and y are integers representing the number of monomer units, BR, BR1, and BR2 are a monomer, L, L′, L1, L1′, L2 and L2′ are linkers, C, C1, C2 are cations, and A, A1 and A2 are anions, or wherein A2 and C2 can be functional groups different from cations or anions. In various examples, N is the backbone degree of polymerization and N can be any integer from 5 to 5000. In one or more examples, N is from 30 to 500.

35. The solid electrolyte of any of the examples 1-34, wherein the polymer backbone 220, 2100 comprises, but is not limited to, poly(siloxane), poly(ether), poly(butadiene), poly(ethylene), poly(phosphazene), poly(acrylate), poly(methacrylate), poly(acrylamide), polycarbonate, polylactide, polymaleimide or the combination thereof. The polymer backbone is preferably composed of units that are electrochemically and thermally stable. N is the backbone degree of polymerization. N can be any integer from 5 to 5000. In one or more examples, N is from 30 to 500.

36. The solid electrolyte of any of the examples 1-35, wherein the zwitterionic cation moiety C, C1, C2 covalently tethered to the polymer can be selected from any bulky cationic functional groups. In one or more embodiments, the cation contains one or more nitrogen, one or more oxygen, one or more sulfur, one or more phosphorous atoms or moieties or the combination thereof. In some embodiments, the cation can be the cation of but not limited to amine, pyrrolidine, pyrroline, pyrrole, imidazole, pyrazole, piperidine, tetrahydropyridine, pyridine, pyrimidine, pyrazine, pyridazine, naphthyridine, azaindole, triazole, thiazole, triazine, substituted imidazoles, halogenated imidazole (2, or 4-fluoroimidazole, 2, or 4-chloroimidazole, 2, or 4-bromoimidazole, 2, or 4-iodoimidazole, bis or tris-fluoroimidazole, bis or tris-chloroimidazole), tetrahydrofuran, furan, oxazole, isoxazole or combination thereof. The cation mentioned here can be further substituted with alkyl, alkoxy, cyano, nitro, sulfonyl, perfluoroalkyl, trifluoromethyl, aromatic groups or halogens. In one or more examples, the cation moiety is covalently bonded to a linker through one of its nitrogen atoms. In one or more examples, the cation is covalently bonded to a linker through one of its carbon atoms.

37. The solid electrolyte of any of the examples 1-36, wherein, the zwitterionic cation and anion moieties are selected to have a labile interaction with the added salt ions, with percolated networks for ion transport. In one or more examples, variations on zwitterionic cation and anion moiety with electron-withdrawing or bulky groups may increase ion transport rate.

38. The solid electrolyte of any of the examples 1-37, wherein the linker (e.g., L, L1, L2) is selected to have a soft/flexible nature which gives the polymers low glass transition temperature T_{g}, fast segmental motion and improved ion conductivity. The linker can be, but is not limited to, an alkylene chain, an ethylene chain, a thioether chain, a siloxane chain or the combination thereof. The linker can have 1 to 50 carbon atoms or the combination of carbon, oxygen, sulfur and silicon atoms. In one or more embodiments, the linker contains more than three carbons. In one or more embodiments, the linker does not contain an ion binding group. In some embodiments, the linker does not contain an aromatic group. In some embodiments, the linker does not contain a hydrogen bonding group. In some embodiments, the linker does not contain an amide group.

39. The solid electrolyte of any of the examples 1-38, wherein the cations of the added salt can be selected from any organic, inorganic or hybrid monovalent, divalent, trivalent, tetravalent, pentavalent, hexavalent or higher valent ions or their combinations. In one or more embodiments, the ions (cations) can be selected from but not limited to the group of H⁺, H₃O⁺, NH₄⁺, H₃NOH⁺, Li⁺, Na⁺, K⁺, Rb⁺, Cs⁺, Cu⁺, Ag⁺, BiO⁺, methylammonium CH₃NH₃⁺, ethylammonium (C₂H₅)NH₃⁺, alkylammonium, formamidinium NH₂(CH)NH₂⁺, guanidinium C(NH₂)₃⁺, imidazolium C₃N₂H₅⁺, hydrazinium H₂N-NH₃⁺ azetidinium (CH₂)₃NH₂⁺, dimethylammonium (CH₃)₂NH₂⁺, tetramethylammonium (CH₃)₄N⁺, phenylammonium C₆H₅NH₃⁺, pyridinium, arylammonium, heteroarylammonium, triazolium, Mg²⁺, Ca²⁺, Sr²⁺, Ba²⁺, Ti²⁺, V²⁺, Ni²⁺, Cr²⁺, Co²⁺, Fe²⁺, Sn²⁺, Cu²⁺, Ag²⁺, Zn²⁺, Mn²⁺, NH₃CH₂CH₂NH₃²⁺, NH₃(CH₂)₆NH₃²⁺, NH₃(CH₂)₈NH₃²⁺ and NH₃C₆H₄NH₃²⁺, Al³⁺, Cr³⁺, Fe³⁺, Bi³⁺, Sb³⁺, and a combination thereof.

In one or more embodiments, the anions of the added salt can be selected from but not limited to the group of hexafluoroarsenate (AsF₆⁻), perchlorate (ClO₄⁻), hexafluorophosphate (PF₆⁻), tetrafluoroborate (BF₄⁻), trifluoromethanesulfonate or triflate (Tf⁻) (CF₃SO₃⁻), bis(fluorosulfonyl)imide (FSI⁻) and bis(trifluoromethanesulfonyl)imide (TFSI⁻). More examples can be found in various battery related literature.

40. The solid electrolyte of any of the examples 1-39, wherein the zwitterionic monomer 2102 can exist as a copolymer with another monomer or multiple other monomers. The distribution of monomers can be in a random, statistical, or block-like architecture. The purpose of this monomer/these monomers is not limited to, but can include, modulation of the glass transition temperature, increasing the mechanical strength of the material, increasing the thermal stability of the material, increasing the chemical stability of the material, increasing the electrochemical stability of the material, altering the spacing of zwitterionic moieties along the backbone, altering the extent of order in the sample, altering the processability of the zwitterionic polymer, or altering the shape of the ordered domains. The identity of the comonomer(s) is not limited to but can include acrylic, styrenic, siloxane-based, ether-based, or vinyl. The comonomer(s) can optionally bond to a side chain. The side chains can be independently any chemical moiety, including but not limited to, alkanes, alkenes, aromatics, amines, esters, amides, ethers, thioethers, siloxanes, carbamates, carbonates, or derivatives thereof. The monomer, co-monomer and/or the side chains can be fluorinated or perfluorinated. The side chains can each independently comprise at least one polymer selected from, but not limited to, a polyester, a polylactide, a polyether, a polysiloxane, a polyacrylate, a polymethacrylate, a polyamide, a polyacrylamide, a polyurea, a polyurethane, a polycarbonate, a polyalkane, a polyethylene, a polypropylene, a polyisobutylene, a polyalkene, a polybutadiene, a polyisoprene, a polystyrene, or derivatives thereof, or combination thereof. In one or more examples the zwitterionic polymer is polymerized as a block polymer with polystyrene, resulting in mechanically toughened glassy regions exhibiting elastic moduli of >1 GPa at 60° C.

41. The solid electrolyte of any the examples 1-40, wherein charge neutral polymer comprises a nonlinear architecture. The architecture of the charge neutral polymer can include, but is not limited to, graft polymers, ring polymers, or branched polymers.

42. The solid electrolyte of any of the examples 1-41, wherein the solid 200 comprises a blend of the charge neutral polymer characterized by any of the above characteristics or examples with one or more additional polymers. The one or more additional polymers can have compositions selected for various purposes, including but not limited to, modulation of the glass transition temperature, increasing the mechanical strength of the material/solid polymer electrolyte, altering the extent of order within the material/solid polymer electrolyte, altering the processability of the material/charge neutral polymer/solid polymer electrolyte, or altering the shape of the ordered domains in the solid polymer electrolyte.

43. The solid electrolyte of any of the examples 1-42, wherein solid 200 comprises a blend of the charge neutral polymer and a nucleating agent. Example nucleating agents include, but are not limited to, zwitterionic additives, talc, silicon glasses, boron nitride, calcium carbonate, magnesium carbonate, boron nitride, and graphite-based particles. In various examples, these additives may alter the mechanical strength of the electrolyte material and influence the degree of order within the electrolyte. Specifically, blending suitable zwitterionic molecules with charge neutral zwitterionic polymers may further promote the crystallization of the polymer zwitterionic side chains, improve toughness and contact with the electrodes, and facilitate the superionic conduction behavior.

44. The solid electrolyte of any of the examples 1-43 processed to alter properties which may include, but are not limited to, structure of the electrolyte, mechanical response of the electrolyte to deformation, stability of the electrolyte to voltage or temperature, or conductivity of the electrolyte. Processing methods including but not limited to thermal treatment of the sample, alignment under magnetic fields, alignment under electric fields, and mechanical drawing may be used.

45. The solid electrolyte of any of the examples 1-44, wherein the solid has an ion conductivity in a range of 10⁻⁴ siemens per centimeter (S/cm) and 10⁻² S/cm (10⁻⁴ S/cm≤ionic conductivity ≤0.01 S/cm.

46. The solid electrolyte of any of the examples 1-45 comprising a solid polymer electrolyte.

47. The solid electrolyte of any of the examples, wherein the zwitterionic compounds comprise ionic liquid inspired zwitterions comprising the anions and cations that form the solid electrolyte comprising a crystalline solid at temperatures at which the electrolyte is used or operated.

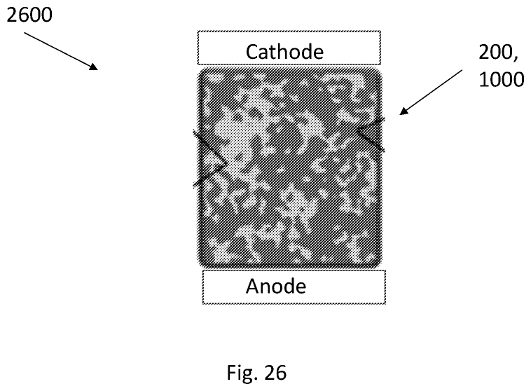

48. FIG. 26 illustrates a battery 2600 comprising the solid electrolyte 200, 1000 of any of the examples 1-47 in contact with an anode and a cathode.

49. The solid electrolyte of any of the examples 1-48, wherein the void spaces 1004 have a first diameter or first width W (see e.g., FIG. 11) larger that a diameter of the alkali metal ion and optionally smaller than the diameter of the anion in the electrolyte salt. In one or more examples, the first width or first diameter is larger than 60 picometers (pm) or 120 picometers (e.g., when the cation in the electrolyte salt is Li⁺) and smaller than 700 picometers (e.g., when the anion in the electrolyte salt is TFSI⁻) or smaller than 580 nm (e.g., when the anion in the electrolyte salt is PF₆⁻) [43]. Some more examples of the diameters of the cations and anions used here can be found in references [39-42], e.g., FIG. 1 of [41] and Table 1 of [42].

50. The solid electrolyte of any of the examples 1-49, wherein the one or more anions in the zwitterionic compound are larger than a SO₃⁻ ion.

51. The solid electrolyte of any of the examples 1-50, wherein the one or more anions in the zwitterionic compound are at least as large as the functional group —SO₂N⁻SO₂—.

52. The solid electrolyte of any of the examples 1-51, wherein the cation in the zwitterionic compound comprises an organic compound covalently bonded to a cation comprising nitrogen or phosphorus.

53. The solid electrolyte of any of the examples 1-53, wherein the anion in the zwitterionic compound comprises at least one of sulfur, phosphorus, oxygen, nitrogen, fluorine or boron.

54. The solid electrolyte of any of the examples 1-53, wherein the anion in the zwitterionic compound comprises oxygen and at least one of sulfur, phosphorus, or nitrogen.

55. The solid electrolyte of any of the examples 1-55, wherein the zwitterionic units each include only one cation covalently bonded to one anion (i.e., one cation-anion pair).

56. The solid electrolyte of example 55, wherein the zwitterionic unit comprises the cation covalently bonded to the anion via a carbon chain (e.g., comprising at least 3 carbon atoms).

57. The solid electrolyte of any of the examples 1-56, wherein the void space dimensions are determined by appropriate selection of at least one of the zwitterion cation and anion sizes, the size/type of the linker between the cation and anion, the size/type of the terminal/tail groups, and the size/type of the linker to the polymer backbone.

58. The solid electrolyte of any of the examples 1-57, wherein the zwitterionic compounds comprise crystalline regions at the operating temperature of the device in the presence of an added alkali metal salt/electrolyte salt, and provide sufficient void space to allow hopping/transport of the alkali metal ion (cation), but ideally the void spaces are too small to permit hopping or transport of counterion (e.g., anion from the electrolyte salt). In one or more examples, the anions of the zwitterion should be sufficiently charge delocalized such that binding interactions between the alkali metal ions and the matrix ions are sufficiently diffuse to allow for hopping to occur. Typically this will require bulky organic ions that are prototypical of ionic liquid compounds. In one or more examples the zwitterions comprise molecules that are larger than linear organic chains comprising 3 carbon atoms.

59. The solid electrolyte of any of the examples 1-58, wherein at least some of the void spaces 1004 comprise the electrolyte salt and/or at least some of the void spaces are empty except for the presence of the alkali metal ion.

60. The solid electrolyte of any of the examples 1-59, wherein the crystalline regions are porous or comprising a porous network forming channels for passage of the alkali metal ions between the cathode and the anode.

61. The solid electrolyte of any of the examples 1-60, wherein the zwitterion comprises the cation (e.g., an imidazole or imidazolium or ammonium) and the anion comprises the functional group R—SO2-N—SO2-R (e.g., ‘sufonimide’ or ‘bis(sulfonimide)’), wherein R can be different groups, e.g., R—SO2-N—SO2-CF3 (trifluoromethanesulfonimide).

### Synthesis Methods for the Compositions Described Herein

### 1. Chemicals

Acrylic acid N-hydroxy succinimide ester (NHS ester acrylate), trifluoromethanesulfonamide, and Sodium 3-Bromopropanesulfonate were purchased from TCI chemicals. The monomer was stored in a refrigerated compartment of a nitrogen containing glovebox until needed. Cyanomethyl dodecyl trithiocarbonate (CDDTC), aminopropyl imidazole, triethylamine (TEA), 3-Bromopropanesulfonic acid sodium salt, and 2,2′-Azobis(2-methylpropionitrile) (AIBN), and dimethylaminoethyl acrylate (DMAEA) were purchased from Sigma Aldrich. Diethyl ether (DEE), methanol (MeOH), tetrahydrofuran (THF), dichloromethane (DCM), and dimethylformamide (DMF) were purchased from Fisher chemicals. Lithium bis(trifluoromethanesulfonyl)imide (Li TFSI) was purchased from Solvonic and stored in a glove box until its use. Anhydrous casting solvents were purchased from Sigma Aldrich and placed and stored in a nitrogen containing glovebox before penetration of the sureseal container. AIBN was recrystallized 3× in methanol to yield white needle-like crystals which were stored at 0° C.

2. Synthesis of poly(NHS-ester acrylate)

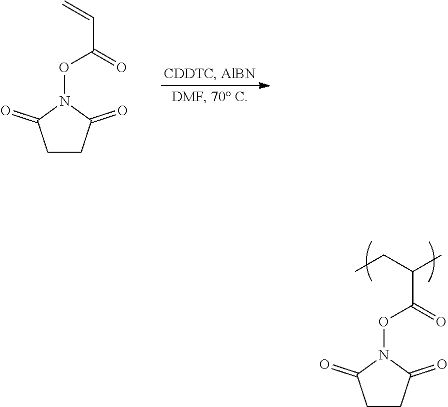

Controlled polymerization of poly(NHS ester acrylate) was performed via Reversible Addition Fragmentation Chain Transfer (RAFT) Polymerization as described by (Evans et al.). 5.246 g of NHS ester acrylate (31.01 mmol, 253 eq.), 39.0 mg of CDDTC (0.123 mmol 1 eq.), and 3.3 mg of AIBN (0.02 mmol, 0.16 eq.) were added to 10 mL of DMF in a 100 mL round bottom flask with a Teflon stir bar. The solution was sparged under stirring with Nitrogen gas and placed in a thermostated oil bath at 70° C. for 18 hours. An aliquot for analysis was taken before the reaction began and immediately before quenching the reaction solution by placing the flask in an ice bath and opening the reactor to ambient conditions.

3. Synthesis of poly(N-(3-(1H-imidazol-1-yl)propyl)acrylamide)

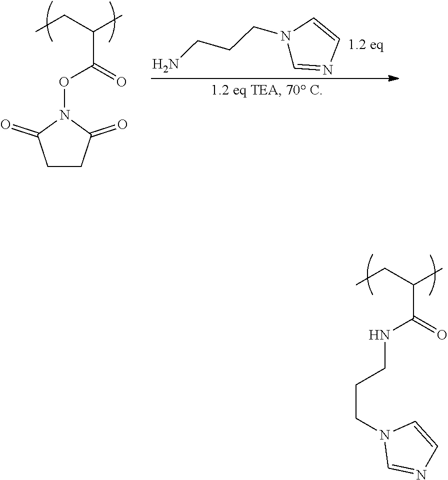

After quenching the polymerization, 1.2 eq. (relative to the monomer) of Aminopropyl imidazole (4.658 g) and TEA (3.761 g) were added to the polymerization reactor. The reaction mixture was returned to the thermostated bath (70° C.) for another 24 hours under stirring. Over this period a small amount of white solid (TEA salts) precipitated from solution. The solution was filtered to remove this solid and subsequently precipitated into 100 mL of DEE to yield a viscous yellow fluid. This fluid was redissolved in THF and precipitated again in DEE. The product was collected and dried in vacuo to yield a yellow solid.

4. Synthesis of ((3-bromopropyl)sulfonyl)((trifluoromethyl)sulfonyl)amide triethylamine salt (TFSI-Br)

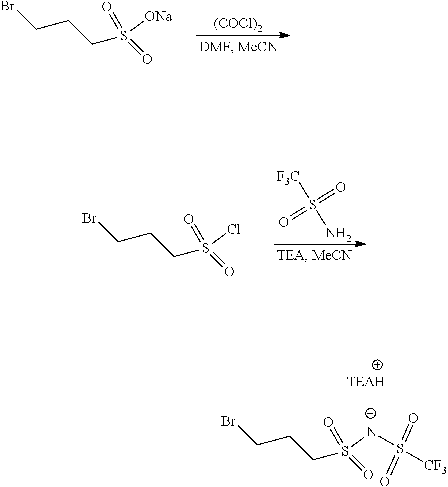

A Schlenk flask with a Teflon coated stir bar was charged with 1 g of 3-Bromopropanesulfonic acid sodium salt. Vacuum was pulled on the powder till the vacuum reached a baseline of ˜10⁻² torr and the solution was repressurized with nitrogen. 5 mL of anhydrous acetonitrile was added to the flask and stirred rapidly to form a suspension. Meanwhile, a second flask was charged with 5 mL acetonitrile and 0.68 g (1.2 eq.) oxalyl chloride and placed under an active nitrogen sparge. After a few minutes of degassing, a catalytic (several drops) quantity of dry DMF was added to the flask. This flask was stirred for 30 minutes and adopted a yellowish color. After the activation of the oxalyl chloride, the Schlenk flask containing the suspension of the sulfonic acid was chilled to 0° C. and the oxalyl chloride solution was added dropwise. The solution was allowed to slowly warm to room temperature overnight leaving a yellowish solution with a white crystalline precipitate. The liquid phase was transferred via syringe to a new Schlenk flask, leaving behind the precipitate. The precipitate was washed with an additional of 3 mL of dry acetonitrile to capture additional entrained product. This wash was also syringe transferred to the same Schlenk flask.

A third Schlenk flask was charged with trifluoromethanesulfonamide 0.66 g (1 eq.) and dried to baseline before adding anhydrous TEA 0.79 g (3 eq.) and 2 mL of anhydrous acetonitrile. This solution was stirred for several minutes and added dropwise via cannula to the sulfonyl chloride containing flask at 0° C. The addition of this solution resulted in immediate formation of white precipitate. This flask was stirred and allowed to reach room temperature overnight. After the overnight rest, the quantity of precipitate increased and the solution had turned brownish-yellow color. This solution was filtered to remove the salts and concentrated by rotatory evaporation to yield a brown oil. This oil was diluted in DCM and washed with distilled water and a dilute aqueous hydrogen chloride solution (0.5 M), in a separatory column. The organic layer was dried over magnesium sulfate and further dried in vacuo to yield a viscous brown oil. Conversion was verified by ¹H and ¹⁹F NMR spectroscopy. ¹H NMR (600 MHz, Chloroform-d) 3.64 (t, J=6.4 Hz, 1H), 3.27-3.21 (t, J=7.4 Hz, 1H), 3.15 (qd, J=7.3, 4.9 Hz, 6H on a triethylamine basis), 2.29-2.21 (m, 1H), 1.29 (t, J=7.3 Hz, 9H on a triethylamine basis).

5. Quaternization of poly(N-(3-(1H-imidazol-1-yl)propyl)acrylamide) to Polyzwitterion (Im-TFSI PZI)

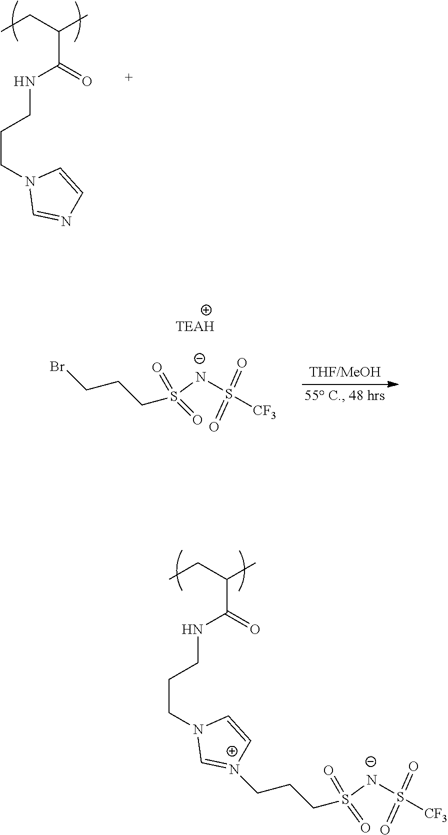

2 g of the dried polymer was redissolved in 8 mL of a 1/1 v/v mixture of THF and MeOH along with 1.5 eq. of Br-TFSI-TEA. The solution was sealed and heated to 55° C. for 48 hours. After 48 hours the solution was concentrated by rotatory evaporation and precipitated into isopropanol to yield a brown solid. The solid was thoroughly washed with IPA, redissolved in DMF and dialyzed (8 kDa Mw cutoff) against MeOH for 5 days with a solvent exchange once per day. The bulk solution remained optically clear even after contact with dialysis solution for 24 hrs. The final product was precipitated one final time in DEE to collect a brown leathery solid. This product was dried in vacuo for 48 hours at 80° C. before salt incorporation.

### 6. Salt Incorporation

Lithium bTFSI salts were incorporated into the PZI by solution casting. In a nitrogen containing glovebox, polymer was dissolved in anhydrous MeOH and a stock solution of LibTFSI salt in anhydrous MeOH was prepared via graviometric measurements. Salt concentration was controlled by volumetric addition of stock solution via a positive displacement micropipette. The solutions were blended until all components were mutually soluble and subsequently flash frozen in liquid nitrogen and placed in vacuo to remove solvent. Polymers were dried for 24 hours at ˜10⁻³ torr in a vacuum oven at room temperature, then for an additional 24 hours at 70° C. These materials were transferred to an ultra-high vacuum oven at 10⁻⁸-10⁻⁹ torr for 24 hours at 55° C. and finally transferred to a nitrogen-containing glovebox for all storage and sample preparation. Salt concentration is parameterized by the molar ratio, ‘r’, of salt to zwitterionic residue (r=[bLiTFSI]/[ZI]).

7. Synthesis of ((3-(1-ethyl-1H-imidazol-3-ium-3-yl)propyl)sulfonyl)((trifluoromethyl)sulfonyl)amide (TFSI-Imidazole ZI)

0.4 g of 1-Ethyl-imidazole and 2.1 g of TFSI-Br were added to a vial along with 10 mL of acetonitrile and a stir bar. The solution was heated to 60° C. under stirring for 96 hours. Stirring, the product was worked up first by precipitation 2× in isopropanol, resulting in a dark viscous liquid. This liquid was subsequently washed repeatedly with dichloromethane until the DCM phase appeared to absorb no color from the wash. After washing with DCM, a brown powdery product was isolated. The powder was dried in a vacuum oven at 70° C. for 48 hours before transferring to a glovebox for all handling. ¹H NMR (600 MHz, DMSO-d6) δ 9.16 (s, 1H), 7.78 (s, 2H), 4.28 (t, J=7.1 Hz, 2H), 4.16 (q, J=7.3 Hz, 2H), 2.99 (t, J=7.4 Hz, 2H), 2.27-2.06 (p, J=7.2 Hz 2H), 1.40 (t, J=7.3 Hz, 3H). ¹³C NMR (151 MHz, dmso) δ 136.40, 122.81, 122.69, 51.52, 47.81, 44.70, 25.30, 15.31.

8. Synthesis of poly(dimethylamino ethyl acrylate) (PDMAEA)

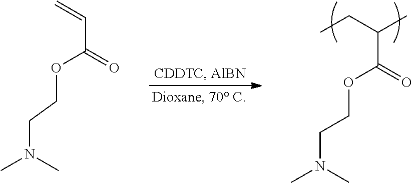

DMAEA was polymerized using standard RAFT techniques. DMAEA monomer was passed through a basic alumina plug to remove inhibitor immediately prior to use (note: it can be difficult to remove inhibitor from this monomer and a second plug was used to attain a clear-colored monomer). The monomer (14.6 g, 0.102 mol, 250 eq.) was added to a heavy-walled and oven-dried reaction flask along with a stir bar, CDDTC (0.148 g, 0.41 mmol, 1 eq.), and AIBN (7 mg, 0.04 mmol, 0.1 eq.) and 30 mL of 1,4 dioxane. The reaction mixture was sparged with nitrogen and submerged in a thermostated oil bath at 70° C. under moderate stirring. The reaction was allowed to proceed for 18 hours before quenching by submerging the reactor in an ice bath and exposing the reaction mixture to air. The polymer was purified by precipitation twice in cyclohexane and dried in vacuo to yield a viscoelastic liquid.

9. Quaternization of PDMAEA to Polyzwitterion with TFSI Anion (Am-TFSI-PZI)

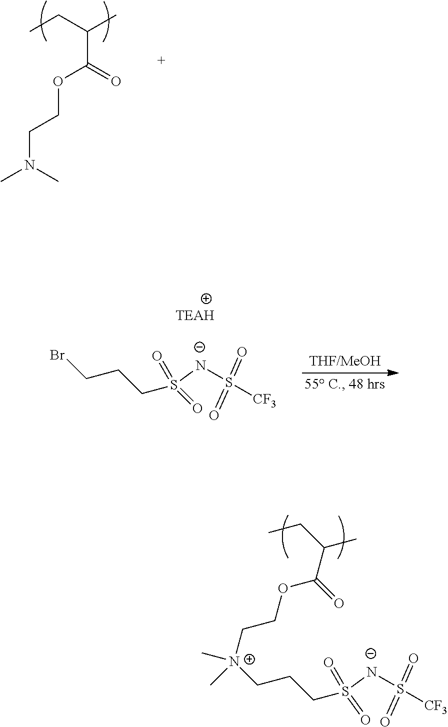

2 g of the dried polymer was redissolved in 8 mL of a 1/1 v/v mixture of THF and MeOH along with 1.5 eq. of Br-TFSI-TEA. The solution was sealed and heated to 55° C. for 48 hours. After 48 hours the solution was concentrated by rotatory evaporation and precipitated into isopropanol to yield a brown solid. The solid was thoroughly washed with IPA, redissolved in DMF and dialyzed (8 kDa Mw cutoff) against MeOH for 5 days with a solvent exchange once per day. The bulk solution remained optically clear even after contact with dialysis solution for 24 hrs. The final product was precipitated one final time in DEE to collect a brown leathery solid. This product was dried in vacuo for 48 hours at 80° C. before salt incorporation.

10. Synthesis of ((3-chloropropyl)sulfonyl)((perfluorophenyl)sulfonyl)amide triethylamine salt (Cl-TFS-C6F5)

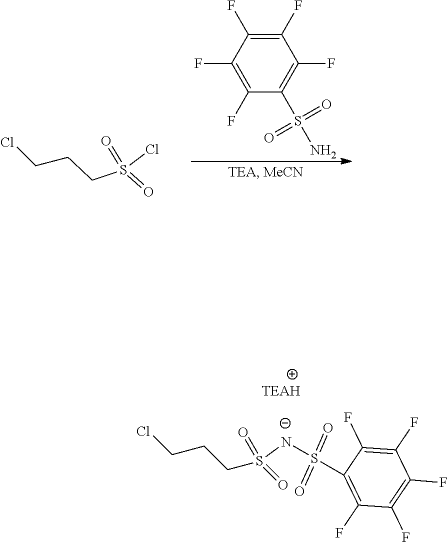 [SMILES: O=S(=O)(Cl)CCCCl ; NS(=O)(=O)c1c(F)c(F)c(F)c(F)c1F ; O=S(=O)(CCCCl)[N-]S(=O)(=O)c1c(F)c(F)c(F)c(F)c1F]

A Schlenk flask was charged with pentafluorophenylsulfonamide [1.02 g, 4.1 mmol] and dried to baseline before adding anhydrous TEA [1.73 mL, 12.4 mmol] and 5 mL of anhydrous acetonitrile. Sulfonyl chloride [0.5 mL, 4.1 mmol] was added dropwise to this stirring solution at 0° C. The addition of the sulfonyl chloride resulted in immediate formation of a white precipitate. This flask was stirred and allowed to reach room temperature overnight. After the overnight rest, the quantity of precipitate increased and the solution had turned brownish-yellow color. This solution was filtered to remove the salts and concentrated by rotatory evaporation to yield a brown oil. This oil was diluted in DCM and washed with distilled water and a dilute aqueous hydrogen chloride solution (0.5 M), in a separatory column. The organic layer was dried over magnesium sulfate, solvent removed in vacuo to yield a viscous brown oil and used in the subsequent step without further purification. Conversion was verified by ¹H and ¹⁹F NMR spectroscopy. ¹H NMR (600 MHz, Chloroform-d) δ 3.70 (t, J=6.4 Hz, 2H), 3.33 (t, J=7.3 Hz, 2H), 3.19 (qd, J=7.3, 4.8 Hz, 6H on TEA Basis), 2.35 (tt, J=13.8, 13.5, 7.5, 7.2 Hz, 2H), 1.38 (t, J=7.3 Hz, 9H on TEA Basis). ¹⁹F NMR (564 MHz, cdcl3) δ −79.05, −116.72, −117.24.

11. Quaternization of PDMAEA to Zwitterion with TFS Anion with Pentafluoro Group

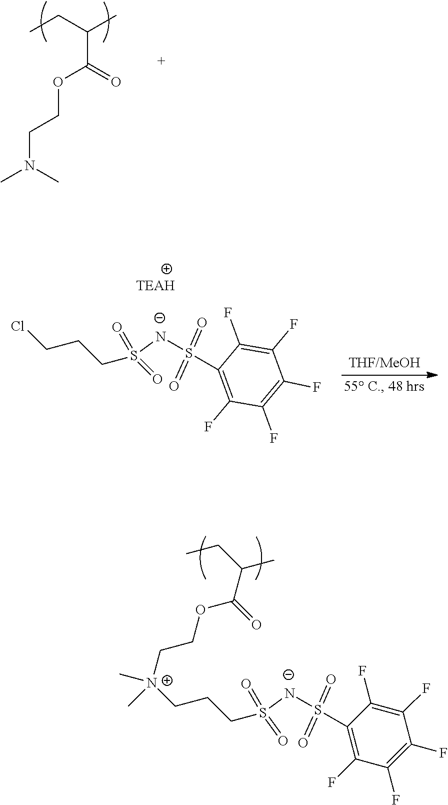

0.277 g of the dried polymer was redissolved in 4 mL of a 1/1 v/v mixture of Acetonitrile and MeOH along with 1.5 eq. of Cl-TFS-C6F5-TEAH (1 g). The solution was sealed and heated to 55° C. for 48 hours. After 48 hours the solution was concentrated by rotatory evaporation and precipitated into isopropanol to yield a brown solid. The solid was precipitated and thoroughly washed with IPA. This product was dried in vacuo for 48 hours at 80° C. before salt incorporation.

### Advantages and Improvements

The grand challenge in the development of polymeric electrolytes has centered around designing electrolytes that are stiff, ionically conductive, and selective for lithium transport. Decades of work in polymer electrolyte research has suggested that ordered domains are deleterious for ion mobility within SPEs. This notion, however, is incompatible with superionic inorganic solid electrolytes, which depend on ordered lattices to enable selective ion motion. The present work demonstrates a new paradigm in which the advantageous mechanisms of inorganic electrolytes can be seamlessly integrated into organic polymers through the molecular engineering of ordered domains, resulting in SPEs with unprecedented lithium-ion conduction and selectivity. These systems illustrate that organic crystals and polymeric zwitterions can be tunable platforms for rapid and selective transport of target ions

### REFERENCES

The following references are incorporated by reference herein.
1. V. Bocharova, A. P. Sokolov, Perspectives for Polymer Electrolytes: A View from Fundamentals of Ionic Conductivity. Macromolecules 53, 4141-4157 (2020).
2. P. G. Bruce, C. A. Vincent, Polymer electrolytes. Journal of the Chemical Society, Faraday Transactions 89, 3187-3203 (1993).
3. D. T. H. Jr., N. P. Balsara, Polymer Electrolytes. Annual Review of Materials Research 43, 503-525 (2013).
4. J. Ling et al., Phosphate Polyanion Materials as High-Voltage Lithium-Ion Battery Cathode: A Review. Energy & Fuels 35, 10428-10450 (2021).
5. W. Li, E. M. Erickson, A. Manthiram, High-nickel layered oxide cathodes for lithium-based automotive batteries. Nature Energy 5, 26-34 (2020).
6. G. Liang, V. K. Peterson, K. W. See, Z. Guo, W. K. Pang, Developing high-voltage spinel LiNi0.5Mn1.5O4 cathodes for high-energy-density lithium-ion batteries: current achievements and future prospects. Journal of Materials Chemistry A 8, 15373-15398 (2020).
7. M. D. Galluzzo, J. A. Maslyn, D. B. Shah, N. P. Balsara, Ohm's law for ion conduction in lithium and beyond-lithium battery electrolytes. The Journal of Chemical Physics 151, 020901 (2019).
8. J. Sun, G. M. Stone, N. P. Balsara, R. N. Zuckermann, Structure-Conductivity Relationship for Peptoid-Based PEO-Mimetic Polymer Electrolytes. Macromolecules 45, 5151-5156 (2012).
9. Y. Wang et al., Design of superionic polymers-New insights from Walden plot analysis. Solid State Ionics 262, 782-784 (2014).
10. K. I. S. Mongcopa et al., Relationship between Segmental Dynamics Measured by Quasi-Elastic Neutron Scattering and Conductivity in Polymer Electrolytes. ACS Macro Letters 7, 504-508 (2018).
11. B. F. Lee et al., Poly(allyl glycidyl ether)—A versatile and functional polyether platform. Journal of Polymer Science Part A: Polymer Chemistry 49, 4498-4504 (2011).
12. B. Park, J. L. Schaefer, Review-Polymer Electrolytes for Magnesium Batteries: Forging Away from Analogs of Lithium Polymer Electrolytes and Towards the Rechargeable Magnesium Metal Polymer Battery. Journal of The Electrochemical Society 167, 070545 (2020).
13. M. M. Hiller, M. Joost, H. J. Gores, S. Passerini, H. D. Wiemhöfer, The influence of interface polarization on the determination of lithium transference numbers of salt in polyethylene oxide electrolytes. Electrochimica Acta 114, 21-29 (2013).
14. J. Fu, Superionic conductivity of glass-ceramics in the system Li 2O—Al 2O 3-TiO 2-P 2O 5. Solid State Ionics 96, 195-200 (1997).
15. P. Bron et al., Li10SnP2S12: An Affordable Lithium Superionic Conductor. Journal of the American Chemical Society 135, 15694-15697 (2013).
16. W. Zhang et al., Degradation Mechanisms at the Li10GeP2S12/LiCoO2 Cathode Interface in an All-Solid-State Lithium-Ion Battery. ACS Applied Materials & Interfaces 10, 22226-22236 (2018).
17. Z. Ning et al., Visualizing plating-induced cracking in lithium-anode solid-electrolyte cells. Nature Materials 20, 1121-1129 (2021).
18. J. Cabana, B. J. Kwon, L. Hu, Mechanisms of Degradation and Strategies for the Stabilization of Cathode-Electrolyte Interfaces in Li-Ion Batteries. Accounts of Chemical Research 51, 299-308 (2018).
19. M. Keller, A. Varzi, S. Passerini, Hybrid electrolytes for lithium metal batteries. Journal of Power Sources 392, 206-225 (2018).
20. L. C. Merrill et al., Polymer-Ceramic Composite Electrolytes for Lithium Batteries: A Comparison between the Single-Ion-Conducting Polymer Matrix and Its Counterpart. ACS Applied Energy Materials 3, 8871-8881 (2020).
21. A. L. Agapov, A. P. Sokolov, Decoupling Ionic Conductivity from Structural Relaxation: A Way to Solid Polymer Electrolytes? Macromolecules 44, 4410-4414 (2011).
22. Y. Wang et al., Decoupling of Ionic Transport from Segmental Relaxation in Polymer Electrolytes. Physical Review Letters 108, 088303 (2012).
23. M. Singh et al., Effect of Molecular Weight on the Mechanical and Electrical Properties of Block Copolymer Electrolytes. Macromolecules 40, 4578-4585 (2007).
24. S. Lascaud et al., Phase Diagrams and Conductivity Behavior of Poly(ethylene oxide)-Molten Salt Rubbery Electrolytes. Macromolecules 27, 7469-7477 (1994).
25. J. R. Keith, V. Ganesan, Ion transport mechanisms in salt-doped polymerized zwitterionic electrolytes. Journal of Polymer Science 58, 578-588 (2020).
26. P. Walden, Innere Reibung und deren Zusammenhang mit dem Leitvermögen. Z. Phys. Chem 55, 207-249 (1906).
27. G. Floudas et al., Dynamics of the “Strong” Polymer of n-Lauryl Methacrylate below and above the Glass Transition. Macromolecules 28, 6799-6807 (1995).
28. G. Floudas, P. Štepánek, Structure and Dynamics of Poly(n-decyl methacrylate) below and above the Glass Transition. Macromolecules 31, 6951-6957 (1998).
29. P. Köberle, A. Laschewsky, V. Tsukruk, The structural order of some novel ionic polymers, 1. X-ray scattering studies. Die Makromolekulare Chemie 193, 1815-1827 (1992).
30. M. Galin, E. Marchal, A. Mathis, J.-C. Galin, Poly(ammonioalkanesulfonate) Blends with Polar Organic Species and Alkali Metal Salts: Structure, Glass Transition and Ionic Conductivity. Polymers for Advanced Technologies 8, 75-86 (1997).
31. C.-U. Lee, A. Li, K. Ghale, D. Zhang, Crystallization and Melting Behaviors of Cyclic and Linear Polypeptoids with Alkyl Side Chains. Macromolecules 46, 8213-8223 (2013).
32. M. Chintapalli et al., Relationship between Conductivity, Ion Diffusion, and Transference Number in Perfluoropolyether Electrolytes. Macromolecules 49, 3508-3515 (2016).
33. N. S. Schauser et al., Decoupling Bulk Mechanics and Mono- and Multivalent Ion Transport in Polymers Based on Metal-Ligand Coordination. Chemistry of Materials 30, 5759-5769 (2018).
34. J. Mindemark, M. J. Lacey, T. Bowden, D. Brandell, Beyond PEO Alternative host materials for Li+-conducting solid polymer electrolytes. Progress in Polymer Science 81, 114-143 (2018).
35. L. M. Robeson, Correlation of separation factor versus permeability for polymeric membranes. Journal of Membrane Science 62, 165-185 (1991).
36. S. S. Seamus D. Jones, Glenn H. Fredrickson, Rachel A. Segalman, The Role of Polymer-Ion Interaction Strength on the Viscoelasticity and Conductivity of Solvent-Free Polymer Electrolytes. Macromolecules, (2020).
37. Q. Chen, C. Huang, R. A. Weiss, R. H. Colby, Viscoelasticity of Reversible Gelation for Ionomers. Macromolecules 48, 1221-1230 (2015).
38. Design and properties of functional zwitterions derived from ionic liquids, Ohno et. al., Physical Chemistry Chemical Physics Issue 16, 2018. DOI https://doi.org/10.1039/C7CP08592C
39. Adv. Electron. Mater. 2020, 6, 2000595. Polymers 2019, 11, 849; doi:10.3390/polym11050849.
40. Inorg. Chem. 1996, 35, 7, 1918-1925.
41. Effects of Counter-Ion Size on Delocalization of Carriers and Stability of Doped Semiconducting Polymers Elayne M. Thomas, Kelly A. Peterson, Alex H. Balzer, Dakota Rawlings, Natalie Stingelin, Rachel A. Segalman, and Michael L. Chabinyc, Adv. Electron. Mater. 2020, 6, 2000595
42. Comparative Analysis of Fluorinated Anions for Polypyrrole Linear Actuator Electrolytes Nguyen Quang Khuyen, Zane Zondaka, Madis Harjo, Janno Torop, Tarmo Tamm, and Rudolf Kiefer Polymers 2019, 11, 849; doi:10.3390/polym11050849
43. Acyclic Sulfur-Nitrogen Compounds. Syntheses and Crystal and Molecular Structures of Bis((trifluoromethyl)sulfonyl)amine ((CF3SO2)2NH), Magnesium Hexaaquo Bis((trifluoromethyl)sulfonyl)amide Dihydrate ([Mg(H2O)6][CF3SO2)2N]2·2H2O), and Bis(bis(fluorosulfonyl)amino)sulfur ((FSO2)2NSN(SO2F)2)|inorganic Chemistry (acs.org)
44. Design of Polymeric Zwitterionic Solid Electrolytes with Superionic Lithium Transport by Seamus D. Jones ACS Cent. Sci. 2022, 8, 2, 169-175, Jan. 4, 2022, wherein the subject matter in [44] was made by or originated from one or more members of the inventive entity of this patent application.

1. A solid electrolyte comprising:
a solid comprising zwitterionic compounds each comprising one or more cations and one or more anions, the zwitterionic compounds comprising at least one of zwitterionic molecules or charge neutral polymers comprising zwitterion pendants; and
an electrolyte salt distributed through the solid such that the solid conducts the alkali metal ions obtained from the salt and the zwitterionic compounds each include zero or more amorphous regions and one or more crystalline regions characterized by:
a presence of Bragg diffraction peaks in an X-ray diffraction measurement of the solid; and
the solid having an ion conductivity of at least 10⁻⁴ S/cm at a temperature of 50 degrees Celsius when:
a molar ratio r of the salt to the zwitterionic monomer units in the charge neutral polymers is 0.9 and the molar ratio r of the salt to the zwitterionic units in the zwitterionic molecules is 0.9; and
wherein the charge neutral polymers each comprise:
a backbone comprising a plurality of backbone monomers; and
a plurality of side chains, each of the side-chains attached to one of the backbone monomers;
at least one of the side chains each include at least one of the zwitterionic monomer units comprising at least one of the cations and at least one of the anions of compensating charge; and
the charge neutral polymers comprise one or more of the crystalline regions and one or more of the amorphous regions.

2. The solid electrolyte of claim 1, wherein the solid comprises a blend of the zwitterionic molecules and the charge neutral polymers.

3. (canceled)

4. The solid electrolyte of claim 1 any of the claims 1-3, wherein:
the zwitterionic molecules each comprise one or more of the cations and one or more of the anions; and
the zwitterionic molecules are located in one or more of the crystalline regions.

5. The solid electrolyte of claim 1, wherein the cations and the anions have sizes and shapes so that the crystalline regions include, or are separated by void spaces or vacancies sufficiently large to selectively allow passage of the alkali metal ions through the voids or vacancies such that the solid conducts the alkali metal ions with a transport number of at least 0.5.

6. The solid electrolyte of claim 1 any of the claims 1-5, wherein the alkali metal ions are preferentially transported through the crystalline regions that form a percolation path through a surrounding matrix comprising the material of the solid.

7. (canceled)

8. The solid electrolyte of claim 1, wherein the crystalline regions are arranged and dimensioned such that a conduction of the alkali metal ions is characterized by ballistic transport in a crystal and
the solid is characterized by a linear elastic modulus of at least 100 kilopascals at room temperature (30 degrees Celsius) under a deformation frequency of 0.1 Hz.

9. (canceled)

10. The solid electrolyte of claim 1 wherein the molar ratio r is in a range 0.05≤r≤2.

11. The solid electrolyte of claim 1, wherein:
the crystalline regions are dimensioned and arranged such that the solid has the ion conductivity of at least 10⁻⁴ S/cm at a temperature 30 of degrees Celsius, and
the transport number for the alkali metal ions is at least 0.5 and
the crystalline regions are dimensioned and arranged such that the solid has the ion conductivity of at least 10⁻⁶ S/cm at a temperature −15 degrees Celsius, and,
the crystalline regions are dimensioned and arranged such that the solid has the ion conductivity of at least 10⁻⁶ S/cm at a temperature 0 degrees Celsius.

12. (canceled)

13. (canceled)

14. (canceled)

15. The solid electrolyte of claim 2, wherein:
the side chains have a regular or periodic spacing along the backbone; and
the cations and anions are sufficiently bulky to allow formation of a free volume between the side chains, the free volume so dimensioned to allow transport of the alkali metal ions through the free volume.

16. The solid electrolyte of claim 1 any of the claims 1-15, wherein:
the side-chains each have an alkyl, an ether, or siloxane linker connecting the zwitterionic monomer to the backbone, and
the linker has a length in a range of 1-30 atoms so as to allow crystallization of the side chains.

17. The solid electrolyte of claim 1, wherein the cation comprises an ammonium or imidazolium and the anion comprises a group having the formula —SO₂N⁻SO₂—.

18. (canceled)

19. (canceled)

20. (canceled)

21. (canceled)

22. (canceled)

23. The solid electrolyte of claim 1 wherein the one or more crystalline regions comprise one or more smectic crystals.

24. (canceled)

25. The solid electrolyte of claim 1 any of the claims 1-24, wherein the zwitterionic compounds comprise the zwitterionic molecules but not the charge neutral polymers.

26. (canceled)

27. The solid electrolyte of claim 1, wherein an ionic conductivity of the electrolyte in the absence of the salt is <10⁻¹⁰ S/cm so that a majority of the conductivity comprises the conductivity of the alkali metal ions.

28. The solid electrolyte of claim 1, wherein the transport number t⁺ is defined as the proportion of the ion conductivity which arises from the alkali metal ions and if the relative concentration of anions and cations are equal, then the transport number can be determined as follows:
$${t}_{+} = \frac{{σ}_{+}}{{σ}_{+} + {σ}_{-}}$$
where σ₊ is a first component of a conductivity of the solid electrolyte arising from the alkali metal ions (cations) and σ₋is a second component of the conductivity attributed to any other ions different from the alkali metal ions, including anions.

29. (canceled)

30. (canceled)

31. The solid electrolyte of claim 1, wherein a salt comprised of the cation and the anion, when separate from the zwitterionic compounds, has a melting temperature below 100 degrees Celsius.

32. The solid electrolyte of claim 1, wherein the anions are ionic liquid like or are larger than anions comprising SO₃.

33. The solid electrolyte of claim 1, wherein the anions and cations are selected from the following:

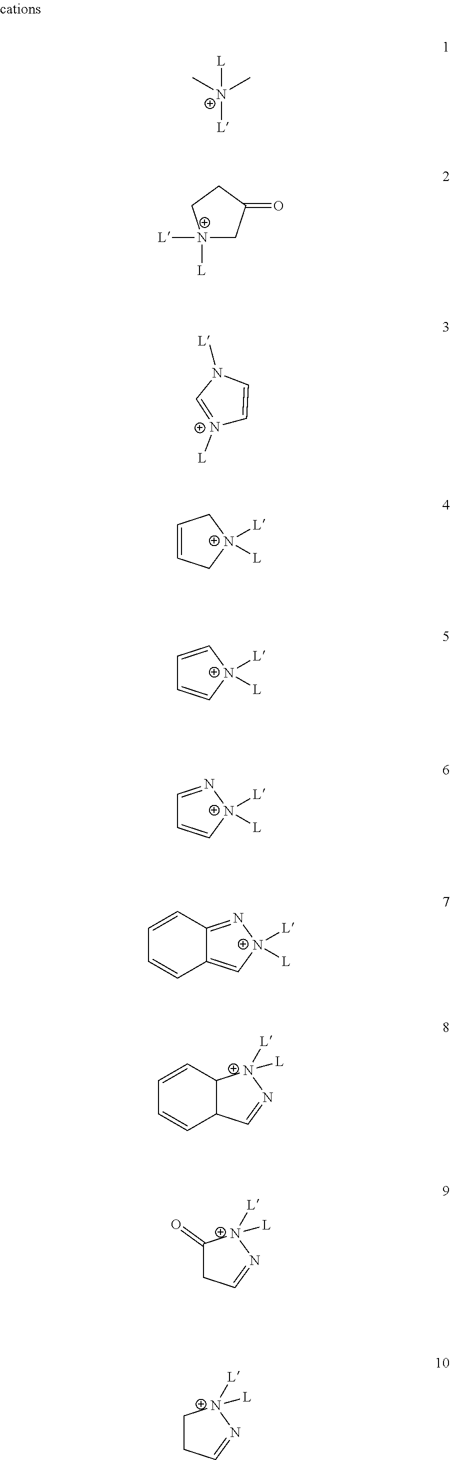

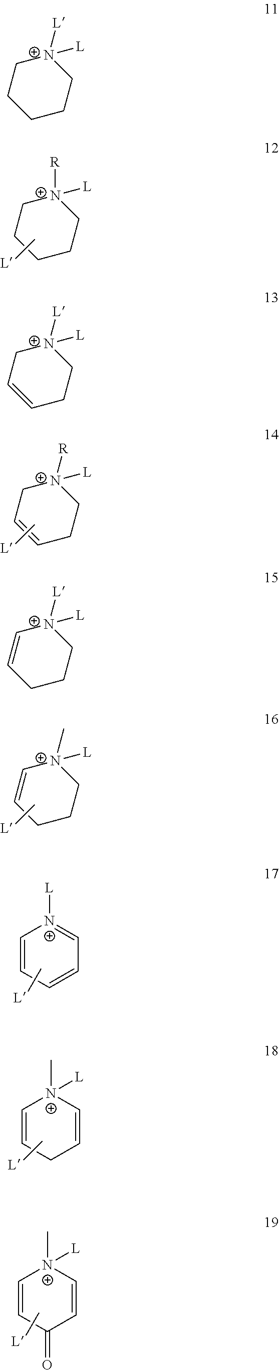

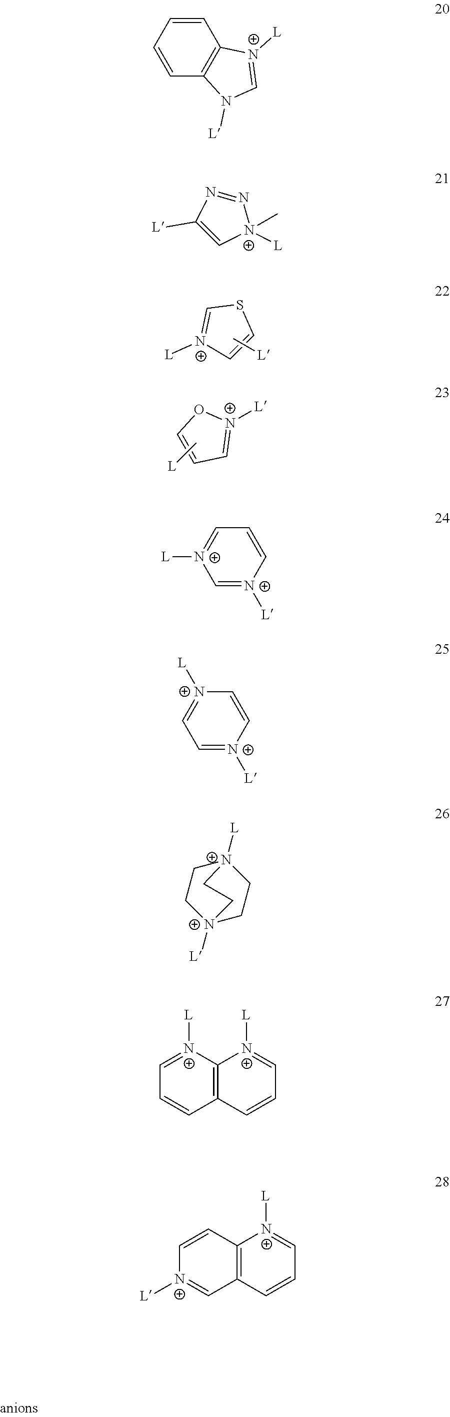

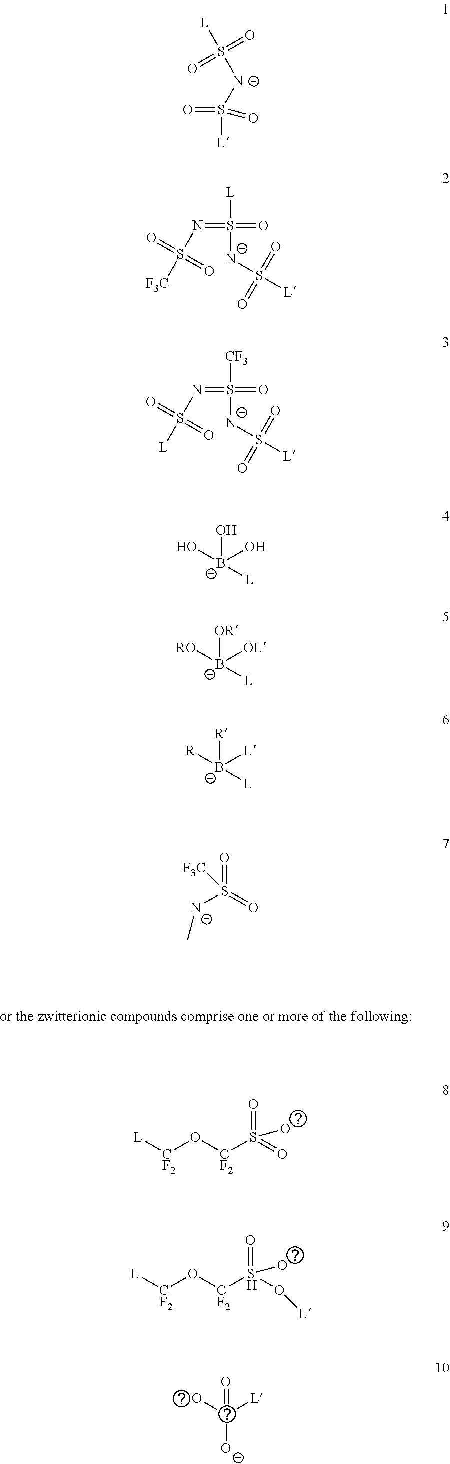

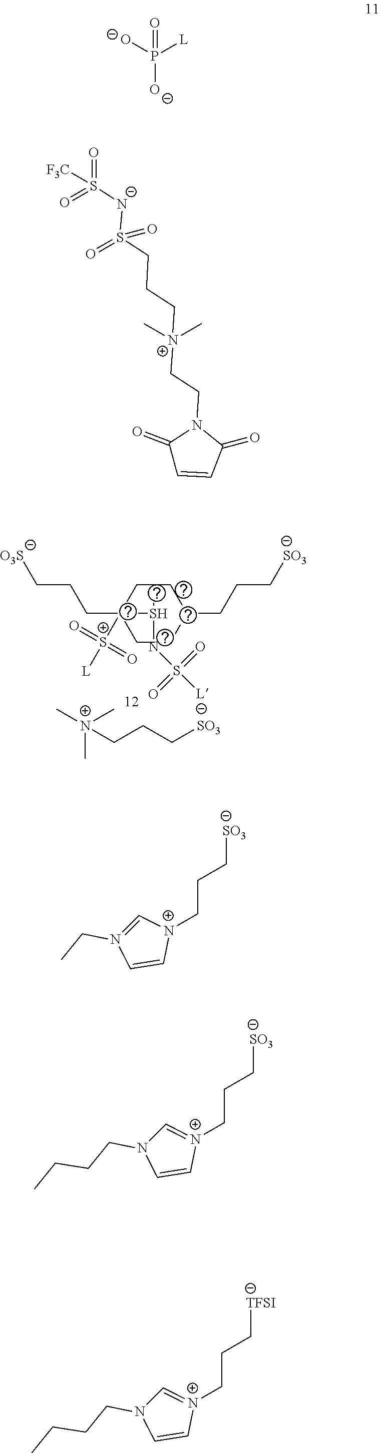

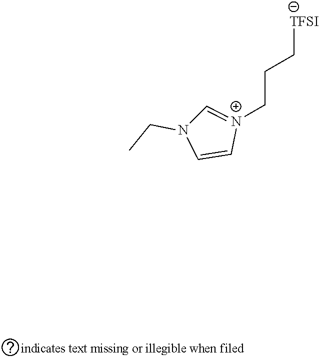

34. The solid electrolyte of claim 1, wherein the zwitterionic compounds comprise ionic liquid inspired zwitterions comprising the anions and cations that form the solid electrolyte comprising a crystalline solid at temperatures at which the electrolyte is used or operated.

35. (canceled)

36. (canceled)
